(19) United States
(12) Patent Application Publication
(10) Pub. No.: US 2021/0324139 A1
(43) Pub. Date: Oct. 21, 2021

(54) Method for Making Polyoxyethylene 1,4 Sorbitan Fatty Acid Ester

(71) Applicants: Lonza Guangzhou Nansha Ltd., Guangzhou (CN); Lonza Ltd, Visp (CH)

(72) Inventors: Dieter Scherer, Laufen (CH); Benjamin Wyler, Bern (CH); Jieping Wei, Guangzhou District, Nansha District (CN); Yanling Yang, Guangzhou, Panyu District (CN); Daniel Shan, Guangzhou, Panyu District (CN); Reta Zhu, Guangzhou, Panyu District (CN); Paul Hanselmann, Brig-Glis (CH); Tania Kjellerup Lind, Copenhagen N (DK); Emelie Josefina Nilsson, Malmö (SE); Vitaly Kocherbitov, Malmö (SE); Johan Engblom, Lund (SE)

(21) Appl. No.: 17/273,386

(22) PCT Filed: Sep. 4, 2019
(86) PCT No.: PCT/EP2019/073509

§ 371 Date: Mar. 4, 2021

Related U.S. Application Data
(60) Provisional application No. 62/745,676, filed on Oct. 15, 2018.

(30) Foreign Application Priority Data
Sep. 5, 2018 (CN) PCT/CN2018/104219
Oct. 15, 2018 (EP) 18 200 298.0
Feb. 13, 2019 (EP) 19 157 032.4
Feb. 14, 2019 (EP) 19 157 068.8
Feb. 14, 2019 (EP) 19 157 297.3
Aug. 30, 2019 (EP) 19 194 776.1
Sep. 3, 2019 (EP) 19 195 046.8

(51) Int. Cl. C08G 65/332

(52) U.S. Cl. CPC C08G 65/3322; C08G 2650/26

(57) ABSTRACT

The invention discloses a method for preparation of polyoxyethylene 1,4-sorbitan fatty acid ester, such as Polysorbate 80, by a reaction of polyoxyethylene 1,4-sorbitan with a fatty acid chloride, and polyoxyethylene 1,4-sorbitan fatty acid esters obtainable by this method.

The invention discloses a method for preparation of polyoxyethylene 1,4-sorbitan fatty acid ester, such as Polysorbate 80, by a reaction of polyoxyethylene 1,4-sorbitan with a fatty acid chloride, and polyoxyethylene 1,4-sorbitan fatty acid esters obtainable by this method.

Polysorbate 80 is a hydrophilic non-ionic surfactant. Due to a good hydrotropic effect, it usually serves as a cosolvent, as an emulsifier, and as a stabilizer during preparation of a formulation of an API or drug for parenteral application, such as injection.

Chang Li et al., International Journal of Nanomedicine, 2014, 9, 2089-2100, in the following also abbreviated with “Li et al.”, describes polysorbates, such as Polysorbate 80, as a class of PNS (polyoxyethylene nonionic surfactants) and their use among others as a nanocarrier system with applications in tablets, emulsions and especially in the preparation of injections. It is used as a facilitator to improve delivery of drugs, especially hydrophobic drugs, such as hydrophobic anticancer drugs, to target tissues. However, due to the different synthetic processes used by different manufacturers to obtain polysorbates, their structure and composition are not identical from batch to batch. For example, in the United States Pharmacopeia 35-National Formulary 30, Polysorbate 80 was defined as a mixture of partial esters of fatty acids, mainly oleic acid, with sorbitol and its anhydrides ethoxylated with approximately 20 moles of ethylene oxide for each mole of sorbitol and sorbitol anhydrides, One method for preparation of Polysorbate 80 involves first the dehydration of sorbitol to a dehydrated derivative, and an esterification with oleic acid providing a sorbitan fatty acid ester, then a polyreaction of ethylene oxide with the sorbitan fatty acid ester.

Another method is to first to do the polyreaction of ethylene oxide with the dehydrated derivative of sorbitan, followed by esterification.

The widely accepted structure of Polysorbate 80 is compound of formula (PS80) with w+x+y+z=20, that is with an average content of EO (ethylene oxide) units of 20.

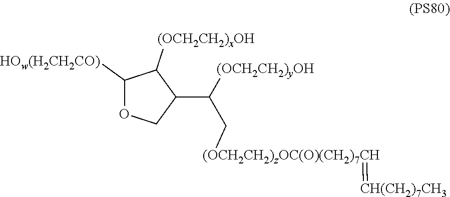

For various reasons Polysorbate 80 is a mixture of many compounds. One source of the diversity is the fatty acid moiety which is oleic acid in case of Polysorbate 80. However, oleic acid is used as a natural product from natural sources, it comprised other fatty acids such as myristic acid, palmitic acid, palmitoleic acid, stearic acid, linoleic acid, or linolenic acid. Thereby the product Polysorbate 80 comprises fatty acid esters not only derived from oleic acid, but also from those other fatty acids which are present in the natural product oleic acid.

As a further source for diversity Li et al. points out that the first step in the synthesis of polysorbate usually is dehydration of sorbitol to sorbitan, suggesting that the final product is a mixture of sorbitol, with general formula of compound of formula (SORBITOL), and sorbitol-derived cyclic ethers with different structures, such as

1,4-sorbitan, with general formula of compound of formula (1,4),

1,5-sorbitan, with general formula of compound of formula (1,5),

2,5-sorbitan, with general formula of compound of formula (2,5), and

1,4:3,6 isosorbide, with general formula of compound of formula (1,4:3,6).

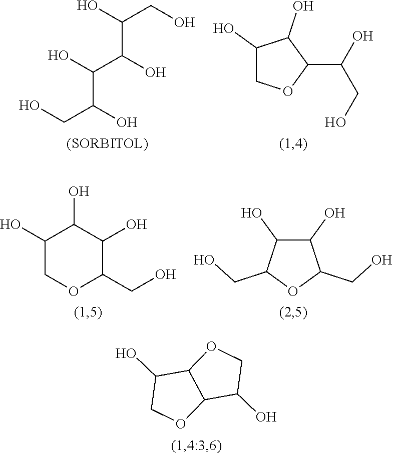

1,4-sorbitan, 1,5-sorbitan, and 2,5-sorbitan are isomers of each other within the meaning of this invention, of not explicitly stated otherwise.

Further byproducts of the dehydration reaction can be sorbitol polymers.

So already the dehydrated product provided by the dehydration of sorbitol is a mixture of different compounds, and when this mixture is then converted with oleic acid and with ethylene oxide to Polysorbate 80, obviously the product called Polysorbate 80 will comprise compounds derived from any of the compounds found in the mixture provided by the dehydration of sorbitol.

Obviously the polyreaction of ethylene oxide again will introduce further diversity as the ethylene oxide can react with each hydroxyl residue of the product from the dehydration reaction of sorbitol, thereby building up a polyoxyethylene chain on the hydroxyl residue, and again varying numbers of ethylene oxide units can be introduced into the various polyoxyethylene chains that build upon the various hydroxyl residues.

Li et al. furthermore points out, that the potential of PNS to trigger pseudoallergy is well known. Pseudo allergy is the official term used by the World Allergy Organization. It is a reaction similar to an immune allergic reaction that is observed following the first administration of the offending agent. Unlike common allergies, pseudoallergic reactions can directly induce release of histamine from mast cells and activate the complement system, with abnormal synthesis of eicosanoids and inhibition of bradykinin degradation, which are not initiated or mediated by pre-existing immunoglobulin E antibodies. Although the exact mechanisms of pseudo allergy in response to PNS remain unclear, it is believed that activation of the complement system and degranulation of mast cells initiate the reactions that result in pseudo allergy, i.e., the initial step of the pseudo allergic reaction is the key step.

There is always the need for polysorbates, especially for Polysorbate 80, that has higher quality and better performance than the known products.

The polysorbate, that is the polyoxyethylene 1,4-sorbitan fatty acid ester, that can be prepared with the method of the invention, shows high purity;
low content of sorbitol, of sorbitan, of 1,4:3,6 isosorbide, of sorbitol polymers, and of any of their isomers;
low content of polyethylene glycol;
low content of PEO isosorbide, of PEO sorbitan and of any of their isomers, such as PEO 1,4-sorbitan;
low content of fatty acids such as oleic acid;
low content of isosorbide fatty acid esters, of sorbitan fatty acid esters and any of their isomers, such as 1,4-sorbitan fatty acid esters, in particular such as 1,4-sorbitan oleate and isosorbide mono-, di- or trioleate;
low content of PEO fatty acid esters, such as PEO mono-, di- or trioleate;
low content of PEO isosorbide fatty acid esters, such as PEO isosorbide mono-, di- or trioleate;
high content of PEO 1,4-sorbitan fatty acid esters, such as PEO 1,4-sorbitan monoesters, PEO 1,4-sorbitan monooleate;
the polysorbate shows low coloration; it has with a narrow distribution of the number of ethylene oxide units; it shows good emulsification and solubilization properties.
The polysorbate, that is the polyoxyethylene 1,4-sorbitan fatty acid ester, that can be prepared with the method of the invention, can be used as an excipient in the formulation of drug formulations, such as an excipient in drug formulation which are applied parenterally. The polysorbate is used to stabilize biologics and vaccines. Particle formation, especially in parenterally applied drug products, can be reduced or even eliminated. Shelf life is prolonged, loss of batches e.g. due to a reduction of particle formation. Particle formation can be measured in a number of ways, such as DLS (Dynamic light scattering) or Raman spectrometry.
Further uses are the use as surfactant, wetting agent, emulsifier and solubilizer. As an emulsifier the polysorbate is used for making emulsions, they can be creams and emulsions for topical and oral use as well as ophthalmic, nasal and otic formulations or formulation which are inhaled. As solubilizer the polysorbate is used for example with poorly soluble drugs, parenterally applied, such as injections, eye drops etc. As stabilizer for biologics, preventing aggregation and reducing interfacial stress, polysorbate is used during manufacturing and in intravenous, subcutaneous and intramuscular injections. The polysorbate shows e.g. a lower CMC (critical micelle concentration) compared to known polysorbates, which means that the amount required for e.g. preparing an emulsion is lower than in case of known polysorbates, or in other words, with the same amount the emulsion is more stable, as can be shown for example by measurement of the Z-potential. CMC can e.g. be measured inter alia with drop volume tensiometric measurements. The polysorbate shows a lowered interfacial tension, as can e.g. be determined by goniometric measurements; also elipsometry can be used for the characterization of the better performance of eth polysorbate compared to known products with regard to its surface (interfacial) properties. The polysorbate shows better performance in the stabilization of proteins. This can inter alia be determined by SWAXD (Small and wide angle X-ray diffraction), Synchroton-SAXS (Synchrotron small angle X-ray scattering), QCM-D (adsorption, Quartz crystal microbalance with dissipation), neutron deflectometry or Z-potential. Also ITC (Isothermal titration calorimetry) is another method to show the better performance of the polysorbate compared to known polysorbates in the interaction with proteins.
Another important aspect are immune reactions. Prominent are different types of immunoreactions when polysorbate is applied parenterally, such as with anticancer drugs, biologics and protein formulations. Compounds like taxol are poorly soluble and require solubilizers like polysorbate. It can become necessary to stop treatment because of immune reactions due to polysorbate, as results can be fatal. From Li et al. it is known that the purity and the low content of byproducts can reduce the risk of immune reactions.

A technical feature of the method of the invention is the use of fatty acid chlorides instead of free fatty acids for the esterification reaction.

### Abbreviations and Other Data

The following terms and abbreviations are used throughout the specification, if not explicitly stated otherwise:
ACN acetonitrile
API Active Pharmaceutical Ingredient
DCM Dichloro methane
DMSO dimethyl sulfoxide
DSC Differential scanning calorimetry
ELSD Evaporative Light Scattering Detector
EO ethylene oxide, MW 44 g/mol
epsilon molar extinction coefficient, unit [L·mol⁻¹·cm⁻¹]
equiv, eq equivalent
Isosorbide has the stereochemistry of compound of formula (3), MW 146.1 g/mol, CAS 652-67-5

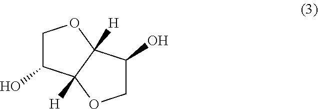

MALDI matrix-assisted laser desorption/ionization, MALDI-TOF was used as MALDI method, if not otherwise stated (TOF time of flight)
MW molecular weight
PEO polyoxyethylene or polyethyleneoxy
PEO sorbitan polyoxyethylene sorbitan, and if not otherwise stated, then PEO 1,4-sorbitan is meant
PNS polyoxyethylene nonionic surfactants
polysorbates in the context of this invention the term polysorbates is used as a synonym for the various products based on polyoxyethylene 1,4-sorbitan fatty acid esters, such as Polysorbate 80
sodiated sodiated adducts means adducts of ionized species with sodium as counter ion
1,4-Sorbitan has the stereochemistry of compound of formula (1), MW 164.2 g/mol, CAS 27299-12-3

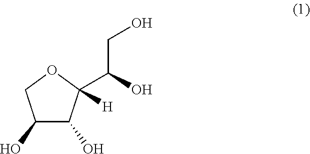 [SMILES: OC[C@@H](O)[C@H]1OC[C@H](O)[C@H]1O]

D-Sorbitol compound of formula (2), MW 182.2 g/mol, CAS 50-70-4

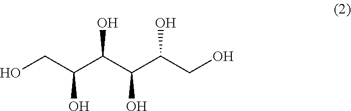 [SMILES: OC[C@@H](O)[C@@H](O)[C@H](O)[C@@H](O)CO]

TBAB Tetrabutylammonium bromide
% percent are percent by weight (wt %), if not stated otherwise
Subject of the invention is a method for preparation of polyoxyethylene 1,4-sorbitan fatty acid ester by a reaction REAC-A of polyoxyethylene 1,4-sorbitan with an acid chloride ACIDCHLOR;
ACIDCHLOR is compound of formula (I);

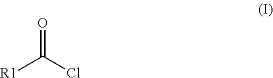

R1 is linear or branched C₁₀₋₂₂ alkyl or linear or branched C₁₀₋₂₂ alkenyl.

Preferably, R1 is linear C₁₀₋₂₂ alkyl or linear C₁₀₋₂₂ alkenyl.
Preferably, ACIDCHLOR is selected from the group consisting of lauric acid, myristic acid, palmitic acid, stearic acid, arachidic acid, oleic acid chloride and a mixture thereof;
more preferably, ACIDCHLOR is selected from the group consisting of lauric acid, palmitic acid, stearic acid, oleic acid chloride and a mixture thereof;

even more preferably, ACIDCHLOR is oleic acid chloride;
Preferably, the polyoxyethylene of the polyoxyethylene 1,4-sorbitan has an average of from 10 to 30, more preferably from 12 to 28, even more preferably from 14 to 26, especially from 16 to 26, more especially from 18 to 24, even more especially from 18 to 23, in particular from 19 to 23, EO units, more in particular from 19 to 22, EO units, even more in particular from 20 to 22, EO units.
In one embodiment, the polyoxyethylene 1,4-sorbitan has an average of from 21 to 22 EO units.
In another embodiment, the polyoxyethylene 1,4-sorbitan has an average of 20 or 22 EO units.
Preferably, the molar equivalent of ACIDCHLOR in REAC-A is from 0.2 to 4 fold, more preferably from 0.4 to 2 fold, even more preferably from 0.6 to 2 fold, especially from 0.8 to 2 fold, more especially from 0.9 to 2 fold, even more especially from 0.9 to 1.8 fold, in particular from 1 to 1.8 fold, of the molar equivalents of polyoxyethylene 1,4-sorbitan.
Preferably, REAC-A is done at a temperature TEMP-A, TEMP-A is from 0 to 70° C., more preferably from 0 to 60° C., even more preferably from 0 to 50° C., especially from 10 to 50° C., more especially from 10 to 40° C., even more especially from 10 to 30° C., in particular from 15 to 25° C., more in particular of from 17.5 to 25° C.
Preferably, the reaction time TIME-A of REAC-A is from 1 min to 4 h, more preferably from 1 min to 2 h, even more preferably 1 min to 1 h, especially from 2 to 45 min, more especially from 5 to 30 min, even more especially from 10 min to 20 min.

REAC-A can be done at atmospheric pressure or at a pressure above atmospheric pressure;

preferably, REAC-A is done at atmospheric pressure.

Preferably, no solvent is present in or charged for or used for REAC-A.

Preferably, no water is charged for or used for REAC-A.

Preferably, no catalyst is charged for or used for REAC-A.
Preferably, REAC-A is done neat, that is the only substances used for or charged for REAC-A are polyoxyethylene 1,4-sorbitan and ACIDCHLOR.

After REAC-A, the polyoxyethylene 1,4-sorbitan fatty acid ester can be isolated by standard methods known to the skilled person in the art. A steam distillation can be done after REAC-A.

Preferably, the polyoxyethylene 1,4-sorbitan is prepared by a reaction REAC-B,

wherein 1,4-sorbitan is reacted with ethylene oxide.
Preferably, the molar equivalent of ethylene oxide in REAC-B acid is from 10 to 30 fold, more preferably from 12 to 28 fold, even more preferably from 14 to 26 fold, especially from 16 to 26 fold, more especially from 18 to 24 fold, even more especially from 18 to 23 fold, in particular from 18 to 22 fold or 19 to 23 fold, more in particular from 19 to 22 fold, even more in particular from 20 to 22, especially particular 20 to 21 fold, of the molar equivalents of 1,4-sorbitan.

Preferably, REAC-B is done in the presence of a base BASE-B.
Preferably, BASE-B is selected from the group consisting of alkali metal C₁₋₄ alkoxide and alkali metal hydroxide.

Preferably, the alkali metal of the alkali metal C₁₋₄ alkoxide is Na or K;
preferably, the C₁₋₄ alkoxide is methoxide, ethoxide, n-propoxide, isopropoxide, n-butoxide or tert-butoxide.

Preferably, the alkyl metal hydroxide is preferably NaOH or KOH.
More preferably BASE-B is selected from the group consisting of sodium of potassium methoxide, sodium of potassium ethoxide, sodium of potassium n-propoxide, sodium of potassium isopropoxide, sodium of potassium n-butoxide, sodium of potassium tert-butoxide, NaOH and KOH;
even more preferably, BASE-B is selected from the group consisting of sodium of potassium methoxide, sodium of potassium ethoxide, sodium of potassium n-butoxide, sodium of potassium tert-butoxide, NaOH and KOH;
especially, BASE-B is selected from the group consisting of sodium methoxide, sodium tert-butoxide, NaOH and KOH;
more especially, BASE-B is selected from the group consisting of sodium methoxide, NaOH and KOH;

even more especially, BASE-B is NaOH or KOH;

in particular, BASE-B is KOH.
Preferably, the molar equivalents of BASE-B in REAC-B is from 0.5 to 3%, more preferably from 0.75 to 2.5, even more preferably from 1 to 2.25%, especially from 1.25 to 2.25%, more especially from 1.5 to 2%, the % being based on the molar amount of 1,4-sorbitan.
Preferably, REAC-B is done in a solvent SOLV-B, SOLV-B is preferably alkylated petroleum, such as naphtha (petroleum), heavy alkylate.
Preferably, the weight of SOLV-B is from 1 to 10 fold, more preferably from 1 to 5 fold, even more preferably from 1 to 4 fold, especially from 1 to 3 fold, of the weight of 1,4-sorbitan.
Preferably, REAC-B is done at a temperature TEMP-B, TEMP-B is from 100 to 200° C., more preferably from 110 to 190° C., even more preferably from 120 to 180° C., especially from 130 to 170° C., more especially of from 140 to 165° C.
Preferably, the reaction time TIME-B of REAC-B is from 1 to 20 h, more preferably from 2 to 15 h, even more preferably from 3 to 10 h, especially from 4 to 8 h.

REAC-B can be done at atmospheric pressure or at a pressure above atmospheric pressure;
preferably, REAC-A is done at a pressure above atmospheric pressure. Preferably, TEMP-B is chosen and the pressure results from the vapor pressure of the reaction mixture of REAC-B resulting from the chosen temperature, especially in case SOLV-B is present.

Preferably, REAC-B is done under inert atmosphere, such as nitrogen or argon atmosphere.
After REAC-B, the PEO sorbitan can be isolated by standard methods known to the skilled person in the art. Any SOLV-B can be removed for example by phase separation, steam distillation or the like, preferably, a steam distillation is done after REAC-B.
In one embodiment, the 1,4-sorbitan is prepared by a method SORBID comprising four consecutive steps STEP1, STEP2, STEP3 and STEP4, wherein
in STEP1 D-sorbitol is dehydrated in a dehydration reaction DEHYDREAC in the presence of p-toluenesulfonic acid and tetrabutylammonium bromide, STEP1 provides a mixture MIX1;

in STEP2 ethanol is mixed with MIX1, STEP2 provides a mixture MIX2;

in STEP3 isopropanol is mixed with MIX2, STEP3 provides a mixture MIX3;

in STEP4 1,4-sorbitan is isolated from MIX3.
The method SORBIT provides 1,4-sorbitan with high yield, high purity, low content of isosorbide, low content D-sorbitol; the method SORBID is economic, has a low number of steps such as filtration and uses a low number of different chemicals. The method SORBID can be done in one reactor.
Preferably, the p-toluene sulfonic acid is used in form of p-toluenesulfonic acid monohydrate; so in any embodiment where p-toluene sulfonic acid is mentioned, the preferred embodiment is p-toluenesulfonic acid monohydrate.

Preferably, no solvent is present in or used for DEHYDREAC.

Preferably, no water is charged for DEHYDREAC.
Preferably, DEHYDREAC is done neat, that is only the three components D-sorbitol, p-toluenesulfonic acid and tetrabutylammonium bromide are used for and are charged for DEHYDREAC.
Preferably, the molar equivalent of p-toluenesulfonic acid in DEHYDREAC acid is from 0.2 to 1.6%, more preferably from 0.4 to 1.4%, even more preferably from 0.6 to 1.2%, especially from 0.6 to 1.0%, of the molar equivalents of D-sorbitol.
Preferably, the molar equivalent of tetrabutylammonium bromide in DEHYDREAC acid is from 1.0 to 3.6%, more preferably from 1.2 to 3.2%, even more preferably from 1.4 to 2.8%, especially from 1.6 to 2.4%, more especially from 1.6 to 2.0%, of the molar equivalents of D-sorbitol.
Preferably, the weight of ethanol mixed in STEP2 is from 0.2 to 5 fold, more preferably from 0.2 to 2 fold, even more preferably from 0.2 to 1 fold, especially from 0.2 to 0.8 fold, more especially from 0.2 to 0.6 fold, even more especially from 0.3 to 0.5 fold, of the weight of D-sorbitol.
Preferably, the weight of isopropanol mixed in STEP2 is from 0.2 to 5 fold, more preferably from 0.2 to 2 fold, even more preferably from 0.2 to 1 fold, especially from 0.2 to 0.8 fold, more especially from 0.2 to 0.6 fold, even more especially from 0.3 to 0.5 fold, of the weight of D-sorbitol.
Preferably, DEHYDREAC is done at a temperature TEMP1, TEMP1 is from 95 to 120° C., more preferably from 100 to 115° C., even more preferably of from 105 to 115° C.
Preferably, the reaction time TIME1-1 of DEHYDREAC is from 4 to 12 h, more preferably of from 6 to 10 h, even more preferably of from 7 to 9 h.
Preferably, DEHYDREAC is done at a pressure PRESS1 below 50 mbar, more preferably below 25 mbar, even more preferably below 15 mbar.
In another embodiment, DEHYDREAC is done at PRESS1 of from 0.001 to 50 mbar, more preferably of from 0.01 to 25 mbar, even more preferably of from 0.1 to 15 mbar, especially of from 1 to 15 mbar, more especially of from 1 to 12.5 mbar.

Preferably, STEP2, STEP3 and STEP4 are done at atmospheric pressure.
Water is formed by DEHYDREAC as the reaction is a dehydration, which removes 1 equiv of water. When the p-toluene sulfonic acid is used in form of p-toluenesulfonic acid monohydrate, it can also be a source of water during DEHYDREAC.

Preferably, water is removed during DEHYDREAC.
Preferably, STEP2 is done at a temperature TEMP2 of from 60 to 90° C., more preferably of from 60 to 85° C., even more preferably of from 65 to 80° C.
Preferably, STEP1 comprises a cooling COOL1 after DEHYDREAC, where MIX1 is cooled from TEMP1 to TEMP2.
Preferably, COOL1 is done in a time TIME1-2, TIME1-2 is from 10 min to 10 h, more preferably from 15 min to 5 h, even more preferably from 15 min to 2 h, especially from 20 min to 1 h.
Preferably, is DEHYDREAC has been done at PRESS1, then the pressure can be brought back from PRESS1 to atmospheric pressure after DEHYDREAC. If STEP1 comprises COOL1 and DEHYDREAC has been done at PRESS1, then the pressure can be brought back from PRESS1 to atmospheric pressure before, during or after COOL1.
Preferably, after the mixing of ethanol, STEP2 comprises a stirring STIRR2 of MIX2 for a time TIME2-1, TIME2-1 is from 30 min to 10 h, more preferably of from 1 to 8 h, even more preferably of from 1 to 6 h, especially from 1 to 4 h, more especially from 1.5 to 3 h.

Preferably, STIRR2 is done at TEMP2.
Preferably, STEP3 is done at a temperature TEMP3-1 of from 10 to 30° C., more preferably of from 15 to 25° C., even more preferably of from 17.5 to 22.5° C.
Preferably STEP2 comprises a cooling COOL2, where MIX2 is cooled from TEMP1 or TEMP2 to TEMP3.

Preferably, COOL2 is done after STIRR2.

Preferably, COOL2 is done from TEMP2 to TEMP3.

Preferably, STEP2 comprises STIRR2 and COOL2, and COOL2 is done after STIRR2.
Preferably, COOL2 is done in a time TIME2-2, TIME2-2 is from 1 to 10 h, more preferably from 1 to 8 h, even more preferably from 1 to 6 h, especially from 1 to 4 h, more especially from 2 to 4 h.
Preferably, after the mixing of isopropanol, STEP3 comprises a cooling COOL3 of MIX3 to a temperature TEMP3-2 of from −5 to 5° C., more preferably of from −2.5 to 2.5° C., even more preferably of from −1 to 2° C.
Preferably, COOL3 is done in a time TIME3-1, TIME3-1 is from 30 min to 10 h, more preferably of from 30 min to 8 h, even more preferably of from 30 min to 6 h, especially from 30 min to 4 h, more especially from 30 min to 2 h.
Preferably, STEP3 comprises a stirring STIRR3 of MIX3, STIRR3 is done for a time TIME3-2, TIME3-2 is from 1 to 12 h, more preferably from 1 to 10 h, even more preferably from 2 to 8 h, especially from 2 to 6 h, more especially from 3 to 5 h.

Preferably, STIRR3 is done after COOL3.

Preferably, STIRR3 is done at TEMP3-2.

More preferably, STIRR3 is done after COOL3 and STIRR3 is done at TEMP3-2.
Preferably, the isolation in STEP4 of 1,4-sorbitan from MIX3 can be done by any means known to the skilled person, such as evaporation of any liquids in MIX3, filtration, centrifugation, drying, or a combination thereof, preferably the isolation is done by filtration.
Preferably, 1,4-sorbitan is isolated in STEP4 from MIX3 by filtration providing a press cake, followed by washing the press cake with isopropanol, followed by drying of the washed press cake.

In one embodiment,
STEP1 comprises consecutively DEHYDREAC and COOL1;
STEP2 comprises after the mixing of ethanol consecutively STIRR2 and COOL2;
STEP3 comprises after the mixing of isopropanol consecutively COOL3 and STIRR3;
STEP4 comprises an isolation of 1,4-sorbitan by a filtration of MIX3, preferably followed by washing and drying.

Preferably, in STEP2 ethanol is charged to MIX1 providing MIX2.

Preferably, in STEP3 isopropanol is charged to MIX2 providing MIX3.

Preferably, STEP1, STEP2 and STEP3 are done consecutively in one and the same reactor.
In another embodiment, the 1,4-sorbitan is prepared by a method SORBIDAQU for preparation of 1,4-sorbitan with three consecutive steps STEP1AQU, STEP2AQU and STEP3AQU, wherein
in STEP1AQU D-sorbitol is dehydrated in a dehydration reaction DEHYDREACAQU in the presence of p-toluenesulfonic acid and tetrabutylammonium bromide, STEP1AQU provides a mixture MIX1AQU;
in STEP2AQU ethanol is mixed with MIX1AQU, STEP2AQU provides a mixture MIX2AQU;
in STEP3AQU isopropanol is mixed with MIX2AQU, STEP3AQU provides a mixture MIX3AQU;
D-sorbitol is used for STEP1AQU in form of a mixture of D-sorbitol with water.
Preferably, D-sorbitol is used for and charged in STEP1AQU in form of a mixture of D-sorbitol with water.
The mixture of D-sorbitol with water which is used for STEP1AQU can be a solution or a suspension of D-sorbitol in water.
Preferably, D-sorbitol is used for STEP1AQU as a mixture of D-sorbitol with water with a content of D-sorbitol of from 20 to 80 wt %, more preferably of from 40 to 80 wt %, even more preferably of from 60 to 80 wt %, especially of from 65 to 75 wt %, in particular of 70 wt %, of D-sorbitol, the wt % being based on the total weight of the mixture of D-sorbitol with water.

Preferably, TBAB is used for STEP1AQU as a mixture of TBAB with water;
more preferably, TBAB is used for and charged in STEP1AQU as a mixture of TBAB with water.

The mixture of TBAB with water can be a solution or a suspension of TBAB in water.
More preferably, TBAB is used for STEP1AQUas a mixture of TBAB with water with a content of TBAB of from 20 to 80 wt %, even more preferably of from 40 to 80 wt %, especially of from 60 to 80 wt %, more especially of from 60 to 75 wt %, even more especially of from 60 to 70 wt %, in particular of 65 wt %, of TBAB, the wt % being based on the total weight of the mixture of TBAB with water.
Preferably, STEP comprises three steps STEP1AQUA, STEP1AQUB and STEP1AQUC.
In STEP1AQUA a mixture of D-sorbitol with water, TBAB and p-toluenesulfonic acid are mixed providing a mixture MIX1AQUA;
in STEP1AQUB water is distilled off in a distillation DIST1A from MIX1AQUA, providing a mixture MIX1AQUB;
in STEP1AQUC MIX1AQUB is stirred providing MIX1AQU.
MIX1AQUA comprises D-sorbitol, TBAB and water.
Preferably, DIST1A is done at a temperature TEMP1A of from 40 to 100° C., more preferably of from 50 to 90° C., even more preferably of from 55 to 85° C., in particular of from 60 to 80° C.
Preferably, DIST1A is done at reduced pressure PRESS1A; PRESS1A is adjusted in such a way that DIST1A takes place at TEMP1A.
Preferably, all water is distilled off from MIX1AQUA in STEP1AQUA.
Preferably, DIST1A is done for such a time period until all water is distilled off from MIX1AQUA.
Preferably, in STEP the stirring of MIX1AQUB is done at a temperature TEMP1C; TEMP1C is from 80 to 120° C.
Preferably, TEMP1C is from 90 to 110° C., more preferably from 100 to 110° C., in particular 105° C.
Preferably, in STEP1AQUC the stirring of MIX1AQUB is done for a time TIME1C providing MIX1AQU, TIME1C is from 2 to 10 h.
Preferably, TIME1C is from 4 to 8 h, more preferably from 5 to 7 h, in particular 6 h.
Preferably, the stirring during TIME1C is done under reduced pressure PRESS1C; in one embodiment PRESS1C is adjusted so the stirring is done stirred under reflux conditions at the chosen TEMP1C, in another embodiment, PRESS is from 40 to 100 mbar, more preferably from 40 to 60 mbar, in particular 50 mbar.
Preferably, after TIME1C the pressure is brought back from PRESS1C to atmospheric pressure by insertion of nitrogen.
Preferably, STEP2AQU and STEP3AQU are done at atmospheric pressure.
Preferably, the p-toluene sulfonic acid is used in form of p-toluenesulfonic acid monohydrate; so in any embodiment where p-toluene sulfonic acid is mentioned, the preferred embodiment is p-toluenesulfonic acid monohydrate.
DEHYDREACAQU takes place in STEP1AQUB, in STEP1AQUC or in both;
preferably DEHYDREACAQU takes place in STEP1AQUB and can also extend into STEP1AQUC.
Preferably, no organic solvent, more preferably no solvent except water, is present in or used for DEHYDREACAQU.
Preferably, no organic solvent, more preferably no solvent except water, is present in or used for STEP1AQU.
Preferably, in DEHYDREACAQU only the three components D-sorbitol, p-toluenesulfonic acid and tetrabutylammonium bromide are used for and are charged for DEHYDREACAQU, with the D-sorbitol being used and charged in form of a mixture of D-sorbitol with water, more preferably also with the TBAB being used and charged in form of a mixture of TBAB with water.
Preferably, the molar equivalent of p-toluenesulfonic acid in DEHYDREACAQU acid is from 0.2 to 1.6%, more preferably from 0.4 to 1.4%, even more preferably from 0.6 to 1.2%, especially from 0.6 to 1.0%, more especially from 0.8 to 1.0%, in particular 0.9%, of the molar equivalents of D-sorbitol.
Preferably, the molar equivalent of tetrabutylammonium bromide in DEHYDREACAQU acid is from 1 to 3%, more preferably from 1.2 to 2.5%, even more preferably from 1.4 to 2%, especially from 1.6 to 1.8%, in particular 1.7%, of the molar equivalents of D-sorbitol.
Preferably, the weight of ethanol mixed in STEP2AQU is from 0.2 to 5 fold, more preferably from 0.2 to 2 fold, even more preferably from 0.2 to 1 fold, especially from 0.2 to 0.8 fold, more especially from 0.2 to 0.6 fold, even more especially from 0.3 to 0.5 fold, in particular 0.4 fold, of the weight of D-sorbitol.
Preferably, the weight of isopropanol mixed in STEP2AQU is from 0.2 to 5 fold, more preferably from 0.2 to 2 fold, even more preferably from 0.2 to 1 fold, especially from 0.2 to 0.8 fold, more especially from 0.2 to 0.6 fold, even more especially from 0.3 to 0.5 fold, in particular 0.4 fold, of the weight of D-sorbitol.
Preferably, STEP2AQU is done at a temperature TEMP2AQU of from 60 to 90° C., more preferably of from 60 to 85° C., even more preferably of from 65 to 80° C., in particular of from 70 to 75° C.
Preferably, STEP1AQU comprises a cooling COOL1AQU after DEHYDREACAQU, preferably after STEP1AQUC, where MIX1AQU is cooled from TEMP1C to TEMP2AQU.
Preferably, COOL1AQU is done in a time TIME1-2AQU, TIME1-2AQU is from 10 min to 10 h, more preferably from 15 min to 5 h, even more preferably from 15 min to 2 h, especially from 20 min to 1.5 h, more especially from 30 to 60 min, in particular 45 min.
If STEP1AQU comprises COOL1AQU and SETP1C has been done at PRESS1C, then the pressure can be brought back from PRESS1C to atmospheric pressure before, during or after COOL1AQU.
Preferably, after the mixing of ethanol with MIX1AQU, STEP2AQU comprises a stirring STIRR2AQU of MIX2AQU for a time TIME2-1AQU, TIME2-1AQU is from 30 min to 10 h, more preferably of from 1 to 8 h, even more preferably of from 1 to 6 h, especially from 1 to 4 h, more especially from 1.5 to 3 h, in particular 2 h.
Preferably, STIRR2AQU is done at TEMP2AQU.
Preferably, crystal seed of 1,4-sorbitan is added to MIX2AQU;
preferably, of from 0.1 to 2 wt %, more preferably of from 0.2 to 1.5 wt %, even more preferably of from 0.3 to 1 wt %, especially of from 0.4 to 0.7 wt %, in particular 0.5 wt %, of crystal seed of 1,4-sorbitan are added, the wt % being based on the weight of D-sorbitol;
preferably, crystal seed of 1,4-sorbitan is added to MIX2AQU after STIRR2AQU.
Preferably, MIX2AQU is a clear solution;
more preferably, MIX2AQU is a clear solution before the addition of crystal seed of 1,4-sorbitan;
more preferably, MIX2AQU after STIRR2AQU is a clear solution;
even more preferably, MIX2AQU after STIRR2AQU and before an addition of crystal seed of 1,4-sorbitan to MIX2AQU is a clear solution.
Preferably, the mixing of isopropanol with MIX2AQU in STEP3AQU is done at a temperature TEMP3-1AQU of from 20 to 70° C., more preferably of from 30 to 60° C., even more preferably of from 40 to 55° C., in particular of from 45 to 50° C.
Preferably after the mixing of ethanol with MIX1AQU, STEP2AQU comprises a cooling COOL2AQU, where MIX2AQU is cooled from TEMP1C or TEMP2AQU to TEMP3-1AQU.
Preferably, COOL2AQU is done after STIRR2AQU.
More preferably, COOL2AQU is done after an addition of crystal seed of 1,4-sorbitan to MIX2AQU.
Preferably, COOL2AQU is done from TEMP2AQU to TEMP3-1AQU.
Preferably, STEP2AQU comprises STIRR2AQU and an addition of crystal seed of 1,4-sorbitan to MIX2AQU and COOL2AQU, and COOL2AQU is done after an addition of crystal seed of 1,4-sorbitan to MIX2AQU.
Preferably, COOL2AQU is done in a time TIME2-2AQU, TIME2-2AQU is from 1 to 10 h, more preferably from 1 to 8 h, even more preferably from 1 to 6 h, especially from 1 to 4 h, more especially from 1 to 3 h, in particular 2 h.
Preferably, crystal seed of 1,4-sorbitan is added to MIX2AQU after STIRR2AQU and before COOL2AQU.
Preferably, the amount of ethanol used in STEP2AQU is such that after the mixing of ethanol with MIX1AQU a clear solution of 1,4-sorbitan in ethanol, preferably at TEMP2AQU, is obtained;
preferably the amount of ethanol is such that said clear solution is a clear solution of 1,4-sorbitan in ethanol at TEMP2AQU and an oversaturated solution at of 1,4-sorbitan in ethanol at temperatures under TEMP2AQU, preferably such as TEMP3-2AQU, with TEMP3-2AQU as defined herein, more preferably such as TEMP3-1AQU;
more preferably the amount of ethanol is such that said clear solution is an oversaturated solution of 1,4-sorbitan in ethanol at TEMP2AQU.
Preferably said clear solution is obtained after STIRR2AQU; more preferably after STIRR2AQU and before an addition of crystal seed of 1,4-sorbitan to MIX2AQU.

Preferably, the amount of ethanol is such that crystallization starts during COOL2AQU; more preferably, the amount of ethanol is such that
after the mixing of ethanol with MIX1AQU a clear solution of 1,4-sorbitan in ethanol, preferably at TEMP2AQU, is obtained; and
the crystallization starts during COOL2AQU;

even more preferably, the amount of ethanol is such that
after the mixing of ethanol with MIX1AQU a clear solution of 1,4-sorbitan in ethanol, preferably at TEMP2AQU, is obtained; and
that said clear solution is a clear solution of 1,4-sorbitan in ethanol at TEMP2AQU and an oversaturated solution at of 1,4-sorbitan in ethanol at temperatures under TEMP2AQU, preferably such as TEMP3-2AQU, more preferably such as TEMP3-1AQU; and
that crystallization starts during COOL2AQU.

Preferably, MIX2AQU after COOL2AQU is a suspension.
Preferably, after the mixing of isopropanol with MIX2AQU, STEP3AQU comprises a cooling COOL3AQU of MIX3AQU to a temperature TEMP3-2AQU of from −5 to 10° C., more preferably of from −2.5 to 7.5° C., even more preferably of from −1 to 6° C., in particular of from 0 to 5° C.
Preferably, COOL3AQU is done in a time TIME3-1AQU, TIME3-1AQU is from 1 to 10 h, more preferably of from 1 to 8 h, even more preferably of from 1 to 6 h, especially from 2 to 6 h, more especially from 2 to 4 h, in particular 3 h.
Preferably, after the mixing of isopropanol with MIX2AQU, STEP3AQU comprises a stirring STIRR3AQU of MIX3AQU.
Preferably, STIRR3AQU is done at TEMP3-2AQU.
Preferably, STIRR3AQU is done for a time TIME3-2AQU, TIME3-2AQU is from 1 to 12 h, more preferably from 1 to 10 h, even more preferably from 1 to 8 h, especially from 2 to 6 h, more especially from 3 to 5 h, in particular 4 h.
Preferably, STIRR3AQU is done after COOL3AQU.
More preferably, STIRR3AQU is done after COOL3AQU and STIRR3AQU is done at TEMP3-2AQU.

Preferably, MIX3AQU is a suspension.
Preferably, the method comprises a STEP4AQU, STEP4AQU is done after STEP3AQU, in STEP4AQU 1,4-sorbitan is isolated from MIX3AQU.
The isolation in STEP4AQU of 1,4-sorbitan from MIX3AQU can be done by any means known to the skilled person, such as evaporation of any liquids in MIX3AQU, filtration, centrifugation, drying, or a combination thereof, preferably the isolation is done by filtration.
Preferably, 1,4-sorbitan is isolated in STEP4AQU from MIX3AQU by filtration providing a presscake, preferably followed by washing the presscake with isopropanol, preferably followed by drying of the washed presscake, preferably the drying takes place at a temperature of from 30 to 70° C., more preferably of from 35 to 65° C., even more preferably of from 40 to 60° C., in particular of from 45 to 55° C.

In one embodiment,
STEP1AQU comprises consecutively DEHYDREACAQU and COOL1AQU;
STEP2AQU comprises after the mixing of ethanol consecutively STIRR2AQU and COOL2AQU;
STEP3AQU comprises after the mixing of isopropanol consecutively COOL3AQU and STIRR3AQU;

preferably,
STEP1AQU comprises consecutively STEP1AQUA, STEP1AQUB, STEP1AQUC and COOL1AQU;
STEP2AQU comprises after the mixing of ethanol consecutively STIRR2AQU and COOL2AQU;
STEP3AQU comprises after the mixing of isopropanol consecutively COOL3AQU and STIRR3AQU.

more preferably,
STEP1AQU comprises consecutively STEP1AQUA, STEP1AQUB, STEP1AQUC and COOL1AQU;
STEP2AQU comprises after the mixing of ethanol consecutively STIRR2AQU, the addition of crystal seed of 1,4-sorbitan to MIX2AQU, and COOL2AQU;
STEP3AQU comprises after the mixing of isopropanol consecutively COOL3AQU and STIRR3AQU.
Preferably, STEP1AQU, STEP2AQU and STEP3AQU are done consecutively in one and the same reactor.
Preferably, ACIDCHLOR is prepared by a reaction REAC-D of compound of formula (II) with thionyl chloride;

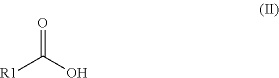

wherein ACIDCHLOR and R1 are defined as herein, also with all their embodiments.
Preferably, no solvent is present in or used for REAC-D.
Preferably, no water is charged for or used for REAC-D.
Preferably, no catalyst is charged for or used for REAC-D.
Preferably, REAC-D is done neat, that is the only substances used for or charged for REAC-D are compound of formula (II) and thionyl chloride.
Preferably, the molar equivalent of thionyl chloride in REAC-D acid is from 1 to 10 fold, more preferably from 2 to 8 fold, even more preferably from 3 to 6 fold, of the molar equivalents of compound of formula (II).
Preferably, REAC-D is done at a temperature TEMP-D, TEMP-D is from 0 to 100° C., more preferably from 10 to 80° C., even more preferably from 20 to 80° C., especially from 30 to 80° C., more especially from 30 to 75° C.
Preferably, the reaction time TIME-D of REAC-D is from 30 min to 10 h, more preferably from 30 min to 5 h, even more preferably from 40 to 2.5 h.
REAC-D can be done at atmospheric pressure or at a pressure above atmospheric pressure;
preferably, REAC-D is done at atmospheric pressure. Preferably, TEMP-D is chosen and the pressure results from the vapor pressure of the reaction mixture of REAC-D resulting from the chosen temperature.
Preferably, REAC-D is done under inert atmosphere, such as nitrogen or argon atmosphere.
After REAC-D, ACCDICHLOR can be isolated by standard methods known to the skilled person in the art. Any residual thionyl chloride can be removed for example by evaporation or the like. The product can be died with conventional methods such as drying under vacuum.
Another subject of the invention is a polyoxyethylene 1,4-sorbitan fatty acid ester obtainable by the method for preparation of polyoxyethylene 1,4-sorbitan fatty acid ester by a reaction REAC-A, with the method and REAC-A as defined herein, also with all its embodiments.
Preferably, the average number of EO units of the PEO 1,4-sorbitan monoester species in said polyoxyethylene 1,4-sorbitan fatty acid ester obtainable by the method for preparation of polyoxyethylene 1,4-sorbitan fatty acid ester by a reaction REAC-A, with the method and REAC-A as defined herein, also with all its embodiments, is from 19 to 23, preferably from 20 to 22, more preferably 20 or 22.
Said average number of EO units of the PEO 1,4-sorbitan monoester species is determined as described in Example 9.
Another subject of the invention is a polyoxyethylene 1,4-sorbitan fatty acid ester which does not contain isosorbide species, such as PEO isosorbide and/or such as PEO isosorbide fatty acid ester;
preferably the analysis is done by MALDI and/or ¹³C NMR and/or HPLC;
preferably, the polyoxyethylene 1,4-sorbitan fatty acid ester has an average content of ethylene oxide units of from 19 to 23, preferably from 20 to 22, more preferably 20 or 22.
Another subject of the invention is a polyoxyethylene 1,4-sorbitan fatty acid ester which does not contain sorbitol species, such as sorbitol ester ethoxylates;
preferably the analysis is done by MALDI;
preferably, the polyoxyethylene 1,4-sorbitan fatty acid ester has an average content of ethylene oxide units of from 19 to 23, preferably from 20 to 22, more preferably 20 or 22.
Another subject of the invention is a polyoxyethylene 1,4-sorbitan fatty acid ester which shows in a MALDI spectrum a signal distribution with only one maximum;
preferably, the polyoxyethylene 1,4-sorbitan fatty acid ester has an average content of ethylene oxide units of from 19 to 23, preferably from 20 to 22, more preferably 20 or 22.
A polyoxyethylene 1,4-sorbitan fatty acid ester wherein the MALDI spectrum of said polyoxyethylene 1,4-sorbitan fatty acid ester shows no signals of substances with a MW
   of over 3500 with signal heights of over 5% relative to the maximum of the whole distribution in the MALDI spectrum, preferably of over 4%, more preferably of over 3%, even more preferably of over 2%, especially of over 1%;
   preferably of over 3400 with signal heights of over 5% relative to the maximum of the whole distribution in the MALDI spectrum, preferably of over 4%, more preferably of over 3%, even more preferably of over 2%, especially of over 1%;
   more preferably of over 3300 with signal heights of over 5% relative to the maximum of the whole distribution in the MALDI spectrum, preferably of over 4%, more preferably of over 3%, even more preferably of over 2%, especially of over 1%;
   even more preferably of over 3200 with signal heights of over 5% relative to the maximum of the whole distribution in the MALDI spectrum, preferably of over 4%, more preferably of over 3%, even more preferably of over 2%, especially of over 1%;
   especially of over 3100 with signal heights of over 5% relative to the maximum of the whole distribution in the MALDI spectrum, preferably of over 4%, more preferably of over 3%, even more preferably of over 2%, especially of over 1%;

preferably, said polyoxyethylene 1,4-sorbitan fatty acid ester has an average content of ethylene oxide units of from 19 to 23, preferably from 20 to 22, more preferably 20 or 22.
Another subject of the invention is a polyoxyethylene 1,4-sorbitan fatty acid ester which does not contain substances with MW of over 3500, preferably of over 3400, more preferably of over 3300, even more preferably of over 3200, especially of over 3100;
the MW of the substances is preferably determined by MALDI;
preferably, the polyoxyethylene 1,4-sorbitan fatty acid ester has an average content of ethylene oxide units of from 19 to 23, preferably from 20 to 22, more preferably 20 or 22.
Another subject of the invention is a polyoxyethylene 1,4-sorbitan fatty acid ester which does show an endothermic signal in DSC with a maximum of the signal at a temperature of −13° C. or lower, preferably of −15° C. or lower, more preferably of −20° C. or lower, even more preferably of −25° C. or lower, especially of −27.5° C. or lower;
the endothermic signal in DSC preferably with a delta H of not more than 35 J/g, more preferably of not more than 30 J/g, even more preferably of not more than 25 J/g, especially of not more than 20 J/g, more especially of not more than 15 J/g, even more especially of not more than 10 J/g, in particular of not more than 5 J/g, more in particular of not more than 1 J/g;
the endothermic signal preferably in a heating cycle of DSC; more preferably an endothermic signal in a first heating cycle of DSC;
preferably, the polyoxyethylene 1,4-sorbitan fatty acid ester has an average content of ethylene oxide units of from 19 to 23, preferably from 20 to 22, more preferably 20 or 22.
Another subject of the invention is a polyoxyethylene 1,4-sorbitan fatty acid ester which does show an endothermic signal in DSC with a delta H of not more than 35 J/g, preferably of not more than 30 J/g, more preferably of not more than 25 J/g, even more preferably of not more than 20 J/g, especially of not more than 15 J/g, more especially of not more than 10 J/g, even more especially of not more than 5 J/g, in particular of not more than 1 J/g;
the endothermic signal in DSC preferably with a maximum of the signal at a temperature of −13° C. or lower, preferably of −15° C. or lower, more preferably of −20° C. or lower, even more preferably of −25° C. or lower, especially of −27.5° C. or lower;
the endothermic signal preferably in a heating cycle of DSC; more preferably an endothermic signal in a first heating cycle of DSC;
preferably, the polyoxyethylene 1,4-sorbitan fatty acid ester has an average content of ethylene oxide units of from 19 to 23, preferably from 20 to 22, more preferably 20 or 22.
Another subject of the invention is a polyoxyethylene 1,4-sorbitan fatty acid ester which does not show an endothermic signal in DSC with a maximum of the signal at a temperature of above −13° C., preferably of above −15° C., more preferably of above −20° C., even more preferably of above −25° C., especially of above −27.5° C.;
the endothermic signal in DSC preferably with a delta H of more than 35 J/g, more preferably or more than 30 J/g, even more preferably of more than 25 J/g, especially of more than 20 J/g, more especially of more than 15 J/g, even more especially of more than 10 J/g, in particular of more than 5 J/g, more in particular of more than 1 J/g;
the endothermic signal preferably in a heating cycle of DSC; more preferably in a first heating cycle of DSC;
preferably, the polyoxyethylene 1,4-sorbitan fatty acid ester has an average content of ethylene oxide units of from 19 to 23, preferably from 20 to 22, more preferably 20 or 22.
Another subject of the invention is a polyoxyethylene 1,4-sorbitan fatty acid ester which does not show an endothermic signal in DSC with a delta H of more than 35 J/g, preferably or more than 30 J/g, more preferably of more than 25 J/g, even more preferably of more than 20 J/g, especially of more than 15 J/g, more especially of more than 10 J/g, even more especially of more than 5 J/g, in particular of more than 1 J/g;
the endothermic signal in DSC preferably with a maximum of the signal at a temperature of above −13° C., more preferably of above −15° C., even more preferably of above −20° C., especially of above −25° C., more especially of above −27.5° C.;
the endothermic signal preferably in a heating cycle of DSC; more preferably in a first heating cycle of DSC;
preferably, the polyoxyethylene 1,4-sorbitan fatty acid ester has an average content of ethylene oxide units of from 19 to 23, preferably from 20 to 22, more preferably 20 or 22.
Another subject of the invention is a polyoxyethylene 1,4-sorbitan fatty acid ester which does not show an exothermic signal in DSC with a delta H of more than 30 J/g, preferably of more than 25 J/g, more preferably of more than 20 J/g, even more preferably of more than 15 J/g, especially of more than 10 J/g, more especially of more than 5 J/g, even more especially of more than 1 J/g;
the exothermic signal in DSC preferably with a maximum of the signal at a temperature of −50° C. or higher; more preferably of −55° C. or higher, even more preferably of −60° C. or higher, especially of −70° C. or higher, more especially of −80° C. or higher;
preferably, the polyoxyethylene 1,4-sorbitan fatty acid ester has an average content of ethylene oxide units of from 19 to 23, preferably from 20 to 22, more preferably 20 or 22.
Another subject of the invention is a polyoxyethylene 1,4-sorbitan fatty acid ester which does not show an exothermic signal in DSC with a maximum of the signal at a temperature of −50° C. or higher; preferably of −55° C. or higher, more preferably of −60° C. or higher, even more preferably of −70° C. or higher, especially of −80° C. or higher;
the endothermic signal in DSC preferably with a delta H of more than 30 J/g, more preferably of more than 25 J/g, even more preferably of more than 20 J/g, especially of more than 15 J/g, more especially of more than 10 J/g, even more especially of more than 5 J/g, in particular of more than 1 J/g;
preferably, the polyoxyethylene 1,4-sorbitan fatty acid ester has an average content of ethylene oxide units of from 19 to 23, preferably from 20 to 22, more preferably 20 or 22.
Another subject of the invention is the use of a polyoxyethylene 1,4-sorbitan fatty acid ester, which is obtainable by the method for preparation of polyoxyethylene 1,4-sorbitan fatty acid ester by a reaction REAC-A,

as an excipient in the formulation of drug formulations;

with the method and REAC-A as defined herein, also with all its embodiments.
Preferably, the drug formulations, for which the polyoxyethylene 1,4-sorbitan fatty acid ester is used as an excipient, are drug formulation which are applied parenterally.
Another subject of the invention is a polyoxyethylene 1,4-sorbitan fatty acid ester which contains 10 wt % or less, preferably of 8 wt % or less, more preferably of 6 wt % or less, even more preferably of 4 wt % or less, especially of 3 wt % or less, more especially of 2 wt % or less, even more especially of 1.5 wt % or less, of PEO isosorbide monooleate, the wt % based on the weight of the sample of the polyoxyethylene 1,4-sorbitan fatty acid ester which is analyzed for its content of PEO isosorbide monooleate.

### FIGURES

The descriptions in the figures means the following, if not otherwise stated:

| | | |
|---|---|---|
| DSC | Exo\hat{ } | Heat flow, exothermic heat |
| | | flow is positive, endothermic |
| | | heat flow is negative, if not |
| | | otherwise stated |
| MALDI | intensity | intensity in arbitrary units |
| | (a.u.) | |
| | m/z | mass divided by charge |
| Preparative | a.u. | intensity in arbitrary units |
| HPLC | | |

FIG. 1 DSC measurement of Example 2, first heating cycle

FIG. 2 DSC measurement of Example 4, first heating cycle

FIG. 3 DSC measurement of Example 5, first heating cycle

FIG. 4 DSC measurement of Example 6, first heating cycle

FIG. 5 DSC measurement of Croda HP, first heating cycle

FIG. 6 DSC measurement of NOF, first heating cycle

FIG. 7 DSC measurement of Example 5, first (solid line) and second (dashed line) cooling cycle

FIG. 8 DSC measurement of Croda HP, first (solid line) and second (dashed line) cooling cycle

FIG. 9 DSC measurement of NOF, first (solid line) and second (dashed line) cooling cycle

FIG. 10 MALDI spectrum of Example 10

FIG. 11 MALDI spectrum of Example 2

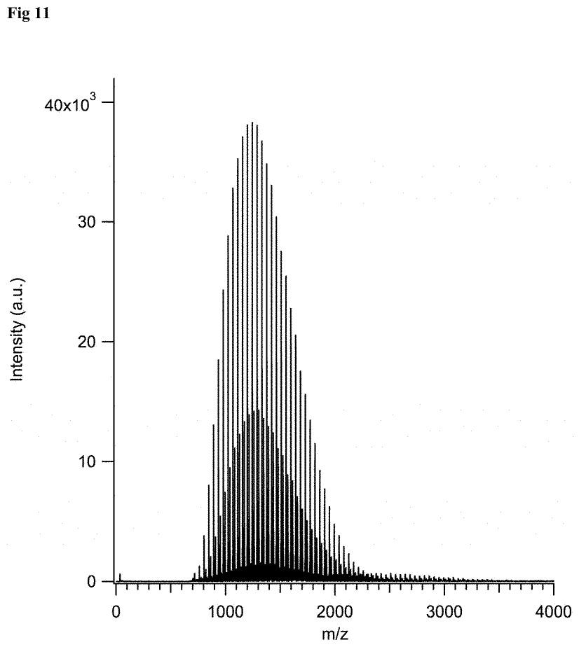

FIG. 12 MALDI spectrum of Example 4

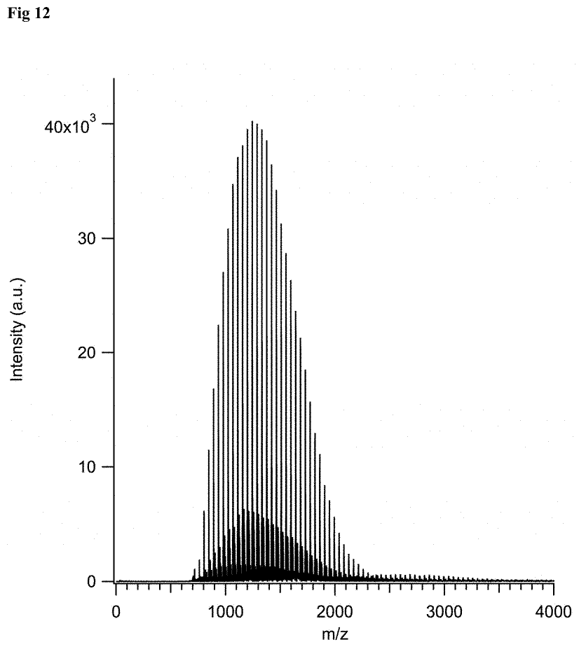

FIG. 13 MALDI spectrum of Example 5

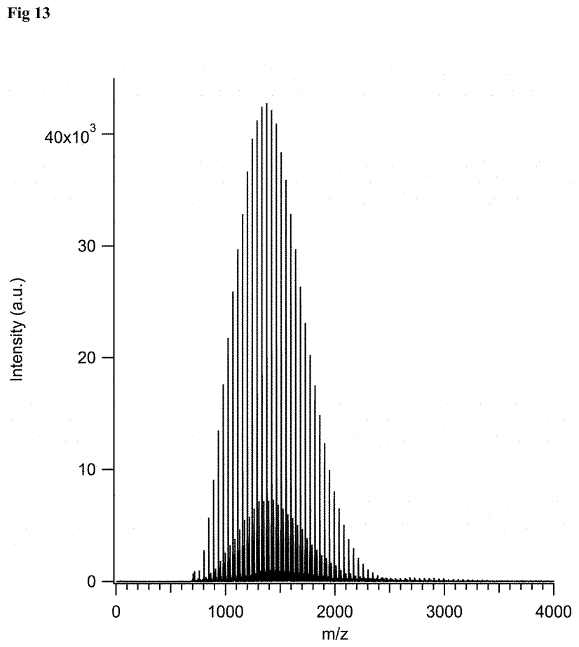

FIG. 14 MALDI spectrum of Example 6

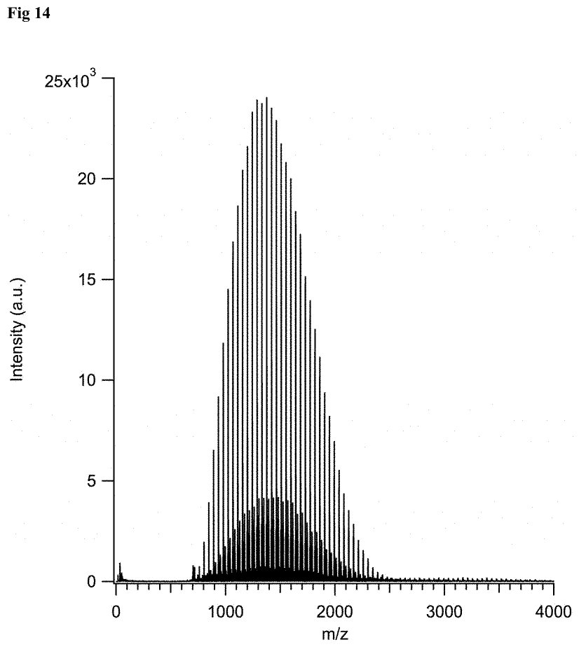

FIG. 15 MALDI spectrum of Example 10 overlaid with curve of Gaussian distribution function

FIG. 16 HPLC chromatogram of preparative HPLC of Example 5, overlay of UV absorption (solid line) and weight distribution (dashed line)

FIG. 17 HPLC chromatogram of preparative HPLC of Croda HP, overlay of UV absorption (solid line) and weight distribution (dashed line)

FIG. 18 HPLC UV chromatogram of preparative HPLC, overlay of Example 5 (solid line) and Croda HP (dashed line)

FIG. 19 HPLC weight chromatogram of preparative HPLC, overlay of Example 5 (solid line) and Croda HP (dashed line)

FIG. 20 Illustration of the analysis of the area of the endothermic valley in the DSC measurement of Example 5, first (solid line) and second (dashed line) heating cycle, the scaling of the y-axis is still normalized indicating the dimension, just without giving the location of the 0 W/g.

FIG. 21 HPCL UV chromatogram of preparative HPLC of Croda HP

FIG. 22a MALDI spectra: Comparison of (A) Example 5, (B) NOF, (C) Croda HP (FIG. 22a) and (D) Croda SR (FIG. 22b)

FIG. 22b MALDI spectra: Comparison of (A) Example 5, (B) NOF, (C) Croda HP (FIG. 22a) and (D) Croda SR (FIG. 22b)

FIG. 23 Polysorbate Synthesis of Croda

FIG. 24 Raw Materials for the two product ranges of Polysorbate of Croda

FIG. 25 Process differences of Croda HP and Croda SR

FIG. 26 Color difference of Croda HP and Croda SR

FIG. 27 MALDI spectrum of the Croda SR

FIG. 28 DSC measurement of Croda SR, first heating cycle

FIG. 29 DSC measurement of Croda SR, first (solid line) and second (dashed line) cooling cycle

FIG. 30a Gaussian distribution function is fitted to the left side of the mass distribution of (A) Example 5, (B) NOF (FIG. 30a), (C) Croda HP and (D) Croda SR (FIG. 30b)

FIG. 30b Gaussian distribution function is fitted to the left side of the mass distribution of (A) Example 5, (B) NOF (FIG. 30a), (C) Croda HP and (D) Croda SR (FIG. 30b)

FIG. 31a Three Gaussian curves fitted to each the three peaks of the MALDI spectra of (B) NOF (FIG. 31a), (C) Croda HP and (D) Croda SR (FIG. 31b), as well as the one Gaussian curve fitted to the one peak in the MALDI spectrum of Example 5 (FIG. 31a).

FIG. 31b Three Gaussian curves fitted to each the three peaks of the MALDI spectra of (B) NOF (FIG. 31a), (C) Croda HP and (D) Croda SR (FIG. 31b), as well as the one Gaussian curve fitted to the one peak in the MALDI spectrum of Example 5 (FIG. 31a).

FIG. 32a One Gaussian curve fitted to all signals of the MALDI spectra of (B) NOF (FIG. 32a), (C) Croda HP and (D) Croda SR (FIG. 32b), as well as the one Gaussian curve fitted to all signals in the MALDI spectrum of Example 5 (FIG. 32a).

FIG. 32b One Gaussian curve fitted to all signals of the MALDI spectra of (B) NOF (FIG. 32a), (C) Croda HP and (D) Croda SR (FIG. 32b), as well as the one Gaussian curve fitted to all signals in the MALDI spectrum of Example 5 (FIG. 32a).

FIG. 33 Calibration curves prepared with the three solutions of PEO isosorbide oleate (concentrations 0.001, 0.002 and 0.006 mg/ml)

### EXAMPLES

### Materials

The following materials were, if not stated otherwise:

| | | No | Quality |
|---|---|---|---|
| Chemicals | Sources | (Batch/Source) | (wt %) |
| PEO sorbitan | Example 10 | | |
| Oleic acid | Green Oleo Srl | 6936 | 91.6 |
| | Cremona, Italy | | |
| Thionyl chloride | Acros Organics | 169490010 | 99.5+ |
| Oxalyl chloride | Acros Organics | 129610010 | 98 |
| Oleoyl chloride | Sigma Aldrich | 367850 | >89 |

Density of thionyl chloride: 1.683 kg/L

NOF Polysorbate 80 (HX2)™, Lot 704352, NOF Corporation, Tokyo, Japan
With MALDI Isosorbide species, such as PEO-isosorbide or PEO-isosorbide-fatty acid ester, and also sorbitol species, such as sorbitol ester ethoxylates, are detectable.
(H)¹³C NMR method: Isosorbide species, such as PEO-isosorbide or PEO-isosorbide-fatty acid ester, are detectable.
(A) HPLC-ELSD method: Isosorbide species, such as PEO-isosorbide or PEO-isosorbide-fatty acid ester, are detectable.
The MALDI spectrum shows a signal distribution with three maxima.
Croda HP Tween® 80HP-LQ-(MH), also called Tween 80 HP, “HP” means “High Purity”, batch number 0001176143, Chemical Description: Polysorbate 80, Croda Europe Limited, 62920 Chocques, France
   With MALDI Isosorbide species, such as PEO-isosorbide or PEO-isosorbide-fatty acid ester, and also sorbitol species, such as sorbitol ester ethoxylates, are detectable.
   (H)¹³C NMR method: Isosorbide species, such as PEO-isosorbide or PEO-isosorbide-fatty acid ester, are detectable.
   (A) HPLC-ELSD method: Isosorbide species, such as PEO-isosorbide or PEO-isosorbide-fatty acid ester, are detectable.
   The MALDI spectrum shows a signal distribution with three maxima.
Croda SR SUPER REFINED® POLYSORBATE 80-LQ-(MH), batch number 0001186606, Chemical Description: Polysorbate 80, Croda Europe Limited, Cowick Hall, Snaith, Goole, DN14 9AA, East Riding of Yorkshire, GB
   With MALDI Isosorbide species, such as PEO-isosorbide or PEO-isosorbide-fatty acid ester, and also sorbitol species, such as sorbitol ester ethoxylates, are detectable.
   (H)¹³C NMR method: Isosorbide species, such as PEO-isosorbide or PEO-isosorbide-fatty acid ester, are detectable.
   (A) HPLC-ELSD method: Isosorbide species, such as PEO-isosorbide or PEO-isosorbide-fatty acid ester, are detectable.
   The MALDI spectrum shows a signal distribution with three maxima.

| | |
|---|---|
| D-Sorbitol | 98 wt % |
| TsOH−H₂O | 99 wt % |
| TBAB | 98 wt % |
| Ethanol | 99 wt % |
| Isopropanol | 99 wt % |

### Methods:

### (A) HPLC-ELSD

HPLC-ELSD is a reversed phase HPLC using Evaporative Light Scattering Detection.

Column: Agilent Zorbax Eclipse XDB-C18 (150 mm×3 mm; 3.5 micrometer)

Pump:
min pressure: 5 bar
may pressure: 400 bar
max flow gradient: 100 mL/min²
Eluent A: ultra pure H₂O
Eluent B: isopropanol
Gradient:

| Time | Flow | | |
|---|---|---|---|
| [min] | [ml/min] | % A | % B |
| 0.0 | 0.3 | 98 | 2 |
| 1 | 0.3 | 98 | 2 |
| 19 | 0.3 | 80 | 20 |
| 64 | 0.3 | 0 | 100 |
| 71 | 0.3 | 0 | 100 |
| 73 | 0.3 | 98 | 2 |
| 83 | 0.3 | 98 | 2 |

Injection:
Injection volume 10 microlitre

Autoinjektor:
Syringe Volume 100 microliter
Injection Mode Injection with needle wash/washing solution: Acetonitrile

Detector
Detector Type ELSD
Temperature 60° C.
Pressure (Gas) 3.5 bar
Gain 10
Filter 8 s

Column oven
Temperature 20° C.

SAT/IN
Unit mV
Description ELSD
Scale Factor 1000
Sampling rate 10

Typical Integration Parameters
Peak Width 250
Threshold 20
Inhibit Integration 42-56 min

Sample preparation:

50 mg+/−5 mg sample were dissolved in 50 ml of acetonitrile.

The percentage determined by an HPLC chromatogram are the area percentage of the respective signal.

The LOD (Limit of Detection) with a Signal-to-noise ratio of 3 was 0.06 area-%.

The LOQ (Limit of Quantification) with a Signal-to-noise ratio of 10 was 0.20 area-%.
No signals with an area-% in HPLC chromatogram of 0.06 or greater means that no isosorbide is detectable.
Signals with an area-% in HPLC chromatogram of from 0.06 to 0.20 means that isosorbide is detectable but not yet quantifiable.
Signals with an area-% in HPLC chromatogram of 0.20 or greater means isosorbide is quantifiable.

### (B) DSC

All measurements were measured in an identical way, the samples were used as such, if not otherwise stated, with sample weights ranging from 2 to 12 mg for the different products. If not otherwise stated the samples were dried in a vacuum pistol over night at room temperature, then they were immediately sealed in a glove bag into 40 microliter aluminum pans with pins, Mettler Toledo, in order to avoid and minimize any uptake of humidity from the atmosphere, and then the pans were subjected to DCS measurements with a DSC 1 STARe system from Mettler Toledo. The samples were run from 25 to −80° C., equilibrated for 5 min at −80° C., then heated from −80 to +80° C., equilibrated for 5 min at +80° C. (denoted 1st cycle). Then this thermal cycle was repeated, +80 to −80° C., equilibration at −80° C., −80 to +80° C., equilibration at +80° C. and then back to 25° C., with all heating and cooling segments at 10° C./min. If not stated otherwise, the heating segments from the first thermal cycle are displayed. If nothing else is reported, the measurement of the second heating cycle produced the same signal as the measurement of the first heating cycle, thereby it was confirmed that the samples did not show any thermal history.

(C) MALDI and DSC from a Preparative HPLC and from Non-Fractionated Samples

### (C1) Sample Preparation and Preparative HPLC

All samples were used as such, if not otherwise stated. The samples were dissolved in ACN to provide a solution with a concentration of 300 mg/ml. 300 microliter of this solution were injected (Waters sample manager 2700) and loaded onto a C18 column (Xterra Prep MS C18 OBD, 5 micrometer, 19×100 mm, Waters). The polysorbate species were separated using an ACN:H2O gradient starting at 45% ACN and increasing to 100% in 30 min with a flow rate at 10 ml/min and a column temperature of 50° C. (Thermostated column compartment TCC-100, Dionex). The separation continued at 100% ACN until reaching 120 min and no more species could be detected. The species were detected with a UV detector (Waters 2487 dual absorbance detector) at 195 nm (lamda max with epsilon=11000 for C═C bonds present in oleic acid). The MassLynx V4.0 software was used for data acquisition. 10 ml fractions were manually collected in 20 ml glass tubes. From each tube 10 microliter were taken out for MALDI analysis prior to evaporation until dryness under vacuum (GeneVac centrifugal evaporator EZ-2, SP Scientific). The evaporated fractions were then used for DSC analysis.

(C2) MALDI of Samples from Preparative HPLC (C1) and of Non-Fractionated Samples

2.5-Dihydroxybenzoic acid (super-DHB>=99.0%, Sigma Aldrich) was used as matrix and prepared as a 5 mg/ml solution in EtOH with 10 mM NaCl added in order to exclusively detect sodiated adducts. Prior to use, the matrix was sonicated for 10 min in a bath in order to obtain a solution. Non-fractionated samples were dissolved in ethanol to provide a solution with a concentration of 5 mg/ml, and for the HPLC fractions the 10 microliter samples were used without further preparation. All samples were mixed 1:1 (vol:vol) with the matrix and vortexed before spotting 1 microliter of each sample onto a target plate (MPT 384 polished steel, Bruker) in triplicates. All sample spots were allowed to dry and crystallize on the plate before MALDI measurements were performed. Positive ion MALDI-TOF mass spectrometry was carried out on an Ultraflex TOF/TOF, Bruker Daltonics instrument equipped with a 337 nm N₂ laser operated at a frequency of 5 Hz in reflection mode. Spectra were recorded at an accelerating voltage of 25 kV and with matrix suppression until 450 Da with 1000 summed acquisitions per measurement. The laser power was kept slightly above the threshold for detection (usually ca. 40%) in order to get optimal peak resolution. All mass spectra were acquired with FlexControl 3.4 and analyzed with the FlexAnalysis 3.4 software.

(C3) DSC of Samples from Preparative HPLC (C1)

The evaporated samples from the preparative HPLC separation were extracted from the 20 ml tubes by dissolving in acetone and transfer (with three washes) to 1.5 ml glass vials equipped with 0.1 ml micro-inserts (Sigma Aldrich). The samples were then evaporated to dryness under vacuum (GeneVac centrifugal evaporator EZ-2, SP Scientific). All samples were afterwards dried overnight in a vacuum pistol before they were transferred to DSC pans (40 microliter, aluminum pans with pins, Mettler Toledo) and sealed in a vacuum bag at controlled humidity (ca. 7% or lower) to avoid uptake of moisture from the atmosphere. The DSC measurements were done as described under the method description (B) DCS

### (D) GC (1,4-Sorbitan)

### Instrument Parameters

| Colum | DB-1 HT (30 m * 0.25 mm * 0.1 μm) | |
|---|---|---|
| | Agilent Technologies, Santa | |
| | Clara, USA | |
| Temperature program: | | |
| Initial; time | 100° C.; 0 min | |
| Rate1; Final 1; Time 1 | 8° C./min; 350° C.; keep 10 min | |
| Run Time | 41.25 | min |
| Equilibration Time | 0.5 | min |
| Mode | Cons. flow | |
| Carrier gas | H₂ | |
| Flow | 1.5 | ml/min |
| Split ratio | 10:1 | |
| Inlet Temperature | 350° | C. |
| Injection Volume | 1 | microliter |
| Detector temperature | 350° | C. |

### Sample Preparation

### Sample Stock Solution

Add 2 g sample to 5 ml pyridine and 10 ml acetic anhydride in a screw-cap bottle (25 mL) and heat up to 120° C. for 2 hours under stirring.

### Sample Solution

0.5 ml of Sample stock solution is added into an auto sampler vial with 1 ml of dichloromethane and mixed

1,4-Sorbitan is detected at ca. 12.3 min.

### (E)¹H NMR

¹H NMR is a routine analytical method for the skilled person, so only one exemplary set of parameters is given in the following which can be used:

Solvent: DMSO-d6

5 to 10 mg of sample are dissolved in 0.6 ml of DMSO-d6 and mixed.

### (F)¹³C NMR

¹³C NMR is a routine analytical method for the skilled person, so only one exemplary set of parameters is given in the following which can be used:

Solvent: DMSO-d6

20 to 50 mg of sample are dissolved in 0.6 ml of DMSO-d6 and mixed well.

### (G) Optical Rotation Method (1,4-Sorbitan)

### Instrument Parameters

| Instrument | MCP 300 of Anton Paar | |
|---|---|---|
| | GmbH, Graz, Austria | |
| Wavelength | 589 | nm |
| Cell | 100.00 | mm |
| Temperature | 20.0° | C. |
| Response | 2 | s |
| Measure | N = 5 | |
| Delay | 10 | s |
| Stable Temperature | ±0.3° | C. |

### Sample Preparation

### Blank

Pure water

### Sample Solution

300±3 mg of 1,4-Sorbitan was added into a 100 ml volumetric flask, then dissolved with water and diluted to volume.

### (H)¹³C NMR Method for Verifying if Isosorbide Species are Present of not

The samples were dissolved in deuterated chloroform prior to the measurements.

Approximately 90 to 120 mg of material were mixed with 0.55 ml of d1-chloroform. 0.5 ml of solution was filled in 5 mm NMR tube. The ¹H-decoupled ¹³C-NMR, ¹³C(¹H)-NMR, were performed with proton decoupling and nuclear Overhauser effect (NOE). The measurements were carried out at 25° C., on a 400 MHz spectrometer at a resonance frequency of 100.61 MHz. The samples were run with 8192 scans using a pulse length of 14.5 micro-sec (90°), a 20 Hz spin, an acquisition time of 1.301 s, and a relaxation delay of 5 s. 32768 complex data points were collected, using a spectral width of 25188.9 Hz (250 ppm). All spectra were Fourier transformed with a line broadening of 1 Hz and zero filling to 128 k data points. The spectra were phase and baseline corrected, and the chloroform peak was used as a reference peak, determined to 77.23 ppm relative to TMS for the ¹³C-NMR.

### Example 1—Oleoyl Chloride with Thionyl Chloride

A two-neck round bottom flask equipped with a stir bar was charged with oleic acid (12.62 g, 40.9 mmol, 1.0 equiv) and the flask was purged with N₂. After heating to 40° C., thionyl chloride (12.5 ml, 172.0 mmol, 4.2 equiv) was added dropwise over 10 min by an addition funnel while stirring, gas evolution was observed. Then the temperature was increased to 65° C. and the reaction mixture was stirred for 1 hour. Then the reaction mixture was cooled to room temperature. Excess SOCl₂ was removed by a rotary evaporator followed by drying under vacuum providing oleoyl chloride. The yield of oleoyl chloride was assumed to be 100%.

### Example 2—Polysorbate 80 with 1.0 Equiv Oleoyl Chloride from Thionyl Chloride

PEO sorbitan (47.1 g, 42.9 mmol, 1.0 equiv), prepared according to Example 10, were weighed into a single-neck round bottom flask and the atmosphere in the flask was exchanged for N₂. Oleoyl chloride, the whole amount that was prepared according to Example 1, was added at room temperature and the reaction mixture was stirred for 15 min at room temperature.

The mixture steam distilled under reduced pressure of ca. 80 mbar for ca. 10 min. The pH was raised by this steam distillation from ca. 1.5 to ca. 4.5.

The product from the steam distillation was used as is for analysis.
(H)¹³C NMR method: No isosorbide species, such as PEO-isosorbide or PEO-isosorbide-fatty acid ester, were detectable.
(A) HPLC-ELSD method: No isosorbide species, such as PEO-isosorbide or PEO-isosorbide-fatty acid ester, were detectable.

### Example 3—Oleoyl Chloride with Thionyl Chloride

A two-neck round bottom flask equipped with a stir bar was charged with oleic acid (30.0 g, 97.3 mmol, 1.0 equiv) and the flask was purged with N₂. After heating to 40° C., thionyl chloride (30 ml, 413.0 mmol, 4.2 equiv) was added dropwise over 10 min by an addition funnel while stirring, gas evolution was observed. Then the temperature was increased to 65° C. and the reaction mixture was stirred for 1 hour. Then the reaction mixture was cooled to room temperature. The excess SOCl₂ was removed by a rotary evaporator followed by drying under vacuum providing oleoyl chloride. The yield of oleoyl chloride was assumed to be 100%.

### Example 4—Polysorbate 80 with 1.2 Equiv Oleoyl Chloride from Thionyl Chloride

PEO sorbitan (22.4 g, 21.4 mmol, 1.0 equiv), prepared according to Example 10, were weighed into a single-neck round bottom flask and the atmosphere in the flask was exchanged for N₂. Oleoyl chloride (7.74 g, 25.7 mmol, 1.2 equiv, prepared according to example 3) was added at room temperature and the reaction mixture was stirred for 15 min at room temperature.

The mixture steam distilled under reduced pressure of ca. 80 mbar for ca. 10 min. The pH was raised by this steam distillation from ca. 1.5 to ca. 4.5.

The product from the steam distillation was used as is for analysis.
(H)¹³C NMR method: No isosorbide species, such as PEO-isosorbide or PEO-isosorbide-fatty acid ester, were detectable.
(A) HPLC-ELSD method: No isosorbide species, such as PEO-isosorbide or PEO-isosorbide-fatty acid ester, were detectable.

### Example 5—Polysorbate 80 with 1.4 Equiv Oleoyl Chloride from Thionyl Chloride

Example 4 was repeated with the difference that 1.4 equiv oleoyl chloride were added instead of 1.2 equiv.
(H)¹³C NMR method: No isosorbide species, such as PEO-isosorbide or PEO-isosorbide-fatty acid ester, were detectable.
(A) HPLC-ELSD method: No isosorbide species, such as PEO-isosorbide or PEO-isosorbide-fatty acid ester, were detectable.

### Example 6—Polysorbate 80 with 1.6 Equiv Oleoyl Chloride from Thionyl Chloride

Example 4 was repeated with the difference that 1.6 equiv oleoyl chloride were added instead of 1.2 equiv.
(H)¹³C NMR method: No isosorbide species, such as PEO-isosorbide or PEO-isosorbide-fatty acid ester, were detectable.
(A) HPLC-ELSD method: No isosorbide species, such as PEO-isosorbide or PEO-isosorbide-fatty acid ester, were detectable.

### Example 7—Oleoyl Chloride with Oxalyl Chloride

A two-neck round bottom flask equipped with a stir bar was charged with oleic acid (2.0 g, 7.1 mmol, 1.0 equiv) and the flask was purged with N₂. DCM (6.5 mL) was added, a clear solution formed. Then oxalyl chloride (1.21 ml, 14.2 mmol, 2.0 equiv) was added dropwise at room temperature over 10 min by an addition funnel while stirring, then the reaction mixture was stirred at room temperature for 2 hour. The DCM and excess oxalyl chloride were removed at the rotary evaporator followed by drying under vacuum. The yield of oleoyl chloride was assumed to be 100%.

### Example 8—Polysorbate 80 with 1.0 Equiv Oleoyl Chloride from Oxalyl Chloride

PEO sorbitan (7.4 g, 7.1 mmol, 1.0 equiv), prepared according to Example 10, were weighed into a single-neck round bottom flask and the atmosphere in the flask was exchanged for N₂. Oleoyl chloride, the whole amount that was prepared according to example 7, was added at room temperature and the reaction mixture was stirred for 15 min at room temperature. The product was used as is for analysis.
(H)¹³C NMR method: No isosorbide species, such as PEO-isosorbide or PEO-isosorbide-fatty acid ester, were detectable.
(A) HPLC-ELSD method: No isosorbide species, such as PEO-isosorbide or PEO-isosorbide-fatty acid ester, were detectable.

### Example 9—Polysorbate 80 with 1.0 Equiv Commercially Available Oleoyl Chloride

PEO sorbitan (5.96 g, 5.7 mmol, 1.0 equiv), prepared according to Example 10, were weighed into a single-neck round bottom flask and the atmosphere in the flask was exchanged for N₂. Oleoyl chloride (1.885 mL, 5.7 mmol, 1.0 equiv, Sigma Aldrich) was added at room temperature and it was stirred for 15 min at this temperature.

The product was used as is for analysis.
(H)¹³C NMR method: No isosorbide species, such as PEO-isosorbide or PEO-isosorbide-fatty acid ester, were detectable.
(A) HPLC-ELSD method: No isosorbide species, such as PEO-isosorbide or PEO-isosorbide-fatty acid ester, were detectable.
   Results from (A) HPLC-ELSD

Table 1 shows the HPLC-ELSD results of Examples 1, 4, 5, 6, 8 and 9, reported are the area % of the elution peaks of the Mono-, Di- and Tri-ester (denoted with “Mono”, “Di” and “Tri” in the Table 1) in the respective HPLC chromatogram; the first value is the absolute percentage of the area of the respective peak (“abs %”) based on the total peak area of the chromatogram, the second value is the percentage of the area of the respective peak based on the sum of the areas of the three peaks (“rel”).

The maximum of the elution peak is observed:
between 27.4 and 27.7 min for the Mono-ester
between 40.3 and 40.6 min for the Di-ester
between 47.2 and 47.3 min for the Tri-ester

The elution peaks of the three esters are well separated from each other.

TABLE 1

| | Mono | | Di | | Tri | |
|---|---|---|---|---|---|---|
| Ex | abs % | rel % | abs % | rel % | abs % | rel % |
| 2 | 28.1 | 60.2 | 13.8 | 29.6 | 4.73 | 10.2 |
| 4 | 30.3 | 56.0 | 17.5 | 32.3 | 6.3 | 11.7 |
| 5 | 30.1 | 43.2 | 27.3 | 39.1 | 12.3 | 17.7 |
| 6 | 27.3 | 33.8 | 34.4 | 42.5 | 19.3 | 23.7 |
| 8 | 29.5 | 61.0 | 14.8 | 30.5 | 4.13 | 8.5 |
| 9 | 28.9 | 62.2 | 13.8 | 29.7 | 3.8 | 8.1 |

Results from (B) DSC

Table 2 shows the DSC results, values of T(peak) and for delta H are an average of 3 DCS analysis per sample in case of Croda HP and NOF, whereas they are values of one DSC analysis in case of Example 2, 4, 5 and 6.

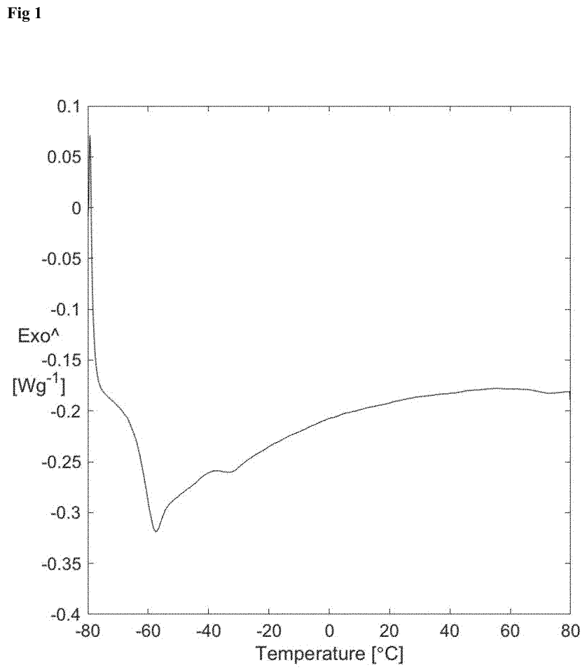

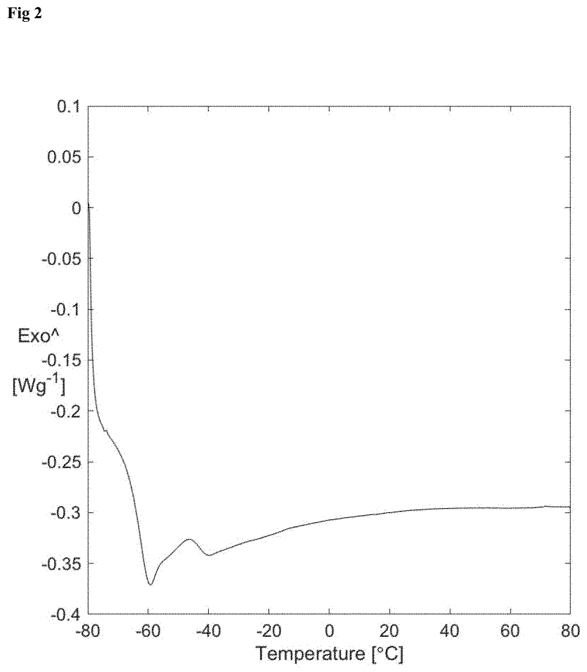

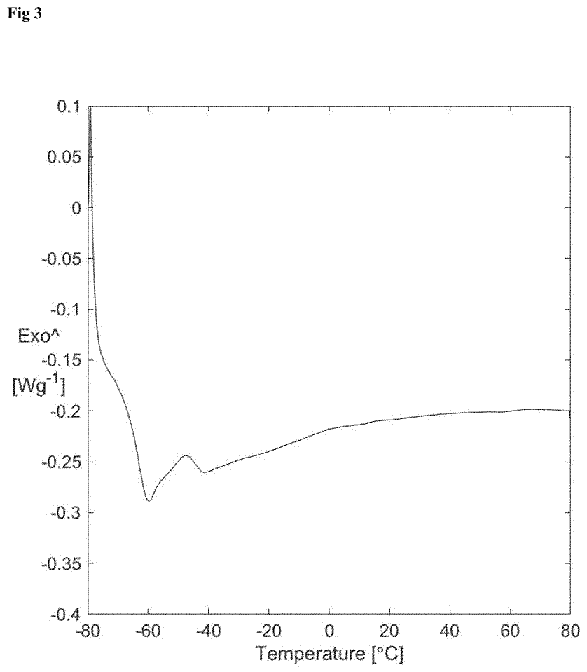

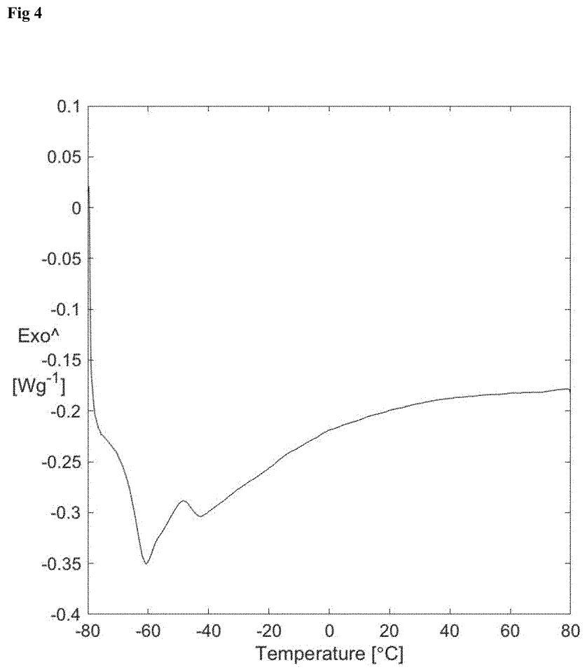

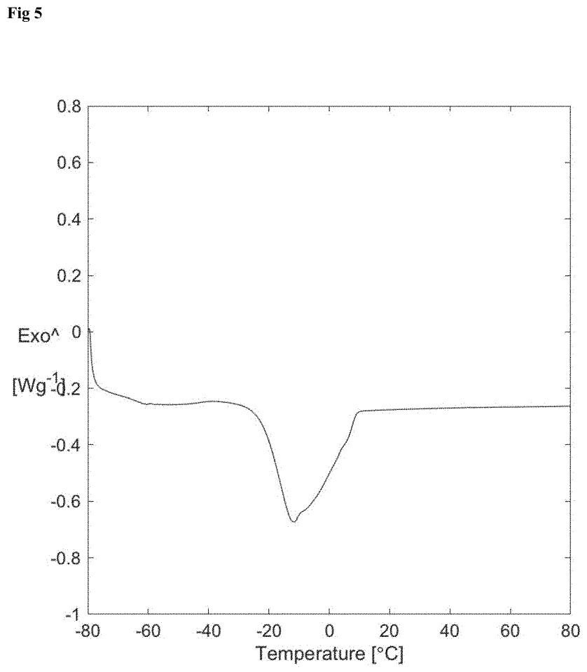

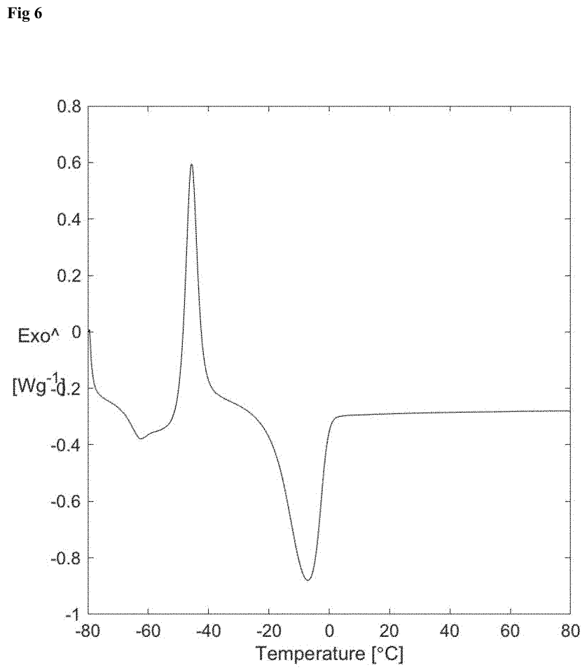

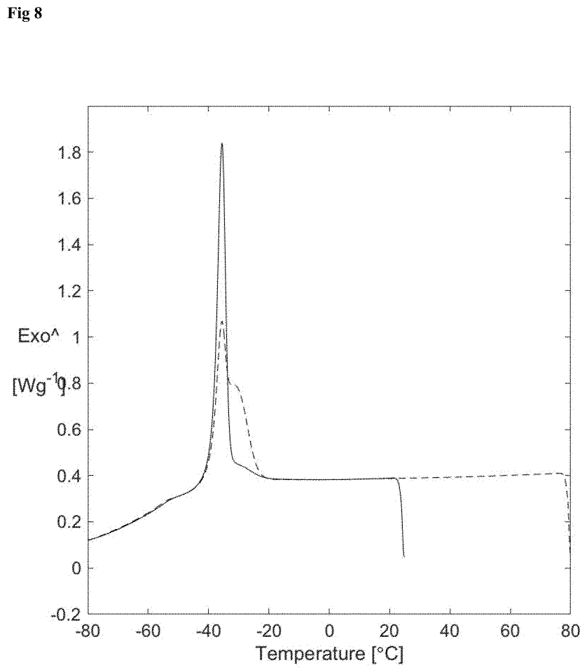

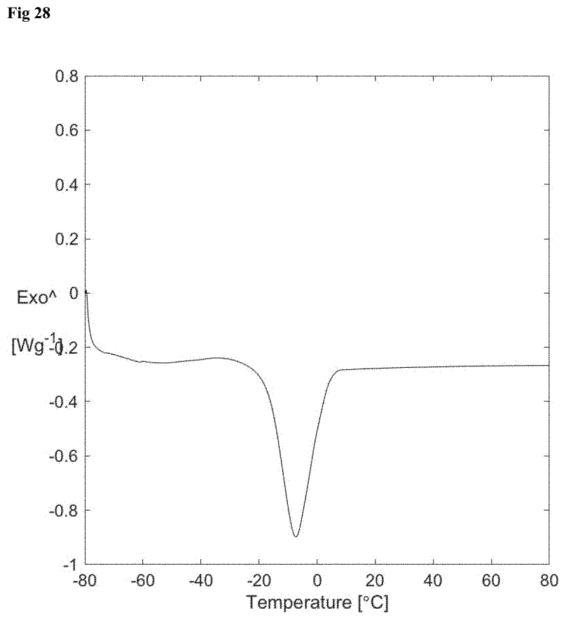

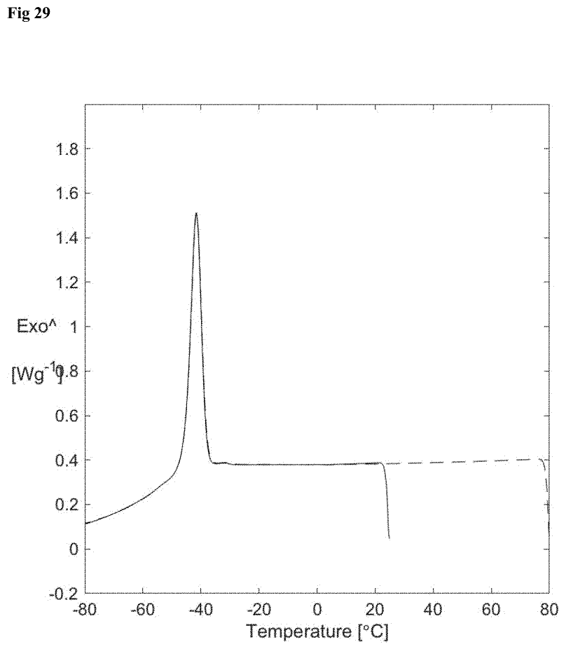

TABLE 2

| | | T(peak) | delta H | |
|---|---|---|---|---|
| Ex | FIGURE | [° C.] | [J/g] | Cycle |
| | Endothermic | | | |
| | Peaks | | | |
| 2 | FIG. 1 | −31.5 | 0.13 | Heating 1st cycle |
| 4 | FIG. 2 | −39.5 | 0.32 | Heating 1st cycle |
| 5 | FIG. 3 | −40.6 | 0.42 | Heating 1st cycle |
| 6 | FIG. 4 | −39.3 | 0.49 | Heating 1st cycle |
| Croda HP | FIG. 5 | −11.6 | 47.7 | Heating 1st cycle |
| NOF | FIG. 6 | −6.5 | 42.0 | Heating 1st cycle |
| Croda SR | FIG. 28 | −7.4 | 46.3 | Heating 1st cycle |
| | Exothermic | | | |
| | Peaks | | | |
| Croda HP | FIG. 8 | −35.2 | 41.7 | Cooling 1st Cycle |
| Croda HP | FIG. 8 | −35.4 | 41.4 | Cooling 2nd Cycle |
| NOF | FIG. 6 | −46.1 | 36.4 | Heating 1st cycle |
| Croda SR | FIG. 29 | −41.5 | 32.4 | Cooling 1st and |
| | | | | 2nd Cycle |

### Discussion of the Curves of the Heating Cycles:

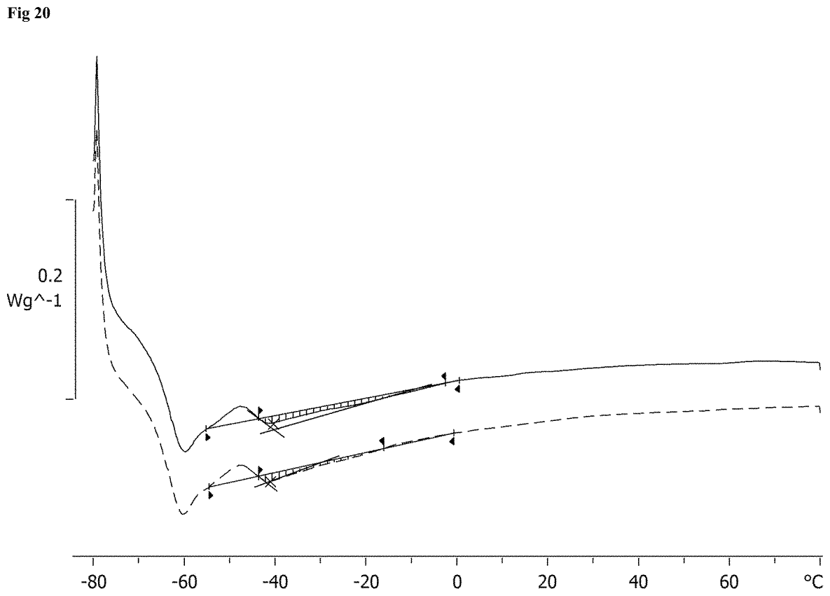

The Croda HP shows in the heating cycle a distinct endothermic peak, which is interpreted to be a melting peak, with a delta H of ca. 48 J/g, at ca. −12° C. (FIG. 5)
The NOF shows in the heating cycle two distinct peaks:
   an endothermic peak, which is interpreted to be a melting peak, with a delta H of ca. 42 J/g, at ca. −7° C.;
   an exothermic peak, which is interpreted to be a melting peak, with a delta H of ca. 36 J/g, at ca. −46° C. (FIG. 6).
The Croda SR shows in the heating cycle distinct endothermic peak, which is interpreted to be a melting peak, with a delta H of ca. 46.3 J/g, at ca. −7.4° C. (FIG. 28)
The DSC of the four Examples 2, 4, 5 and 6 show a slight, non-distinct, not well defined and rather broad endothermic valley between ca. −30 to −40° C. with a delta H of from 0.1 to 0.5 J/g (FIGS. 1 to 4), which is smaller by ca. a factor 100 compared to the delta H of the melting peaks of Croda HP and NOF. The determination of the area of this slight endothermic valley by the program of the DSC instrument is demonstrated in FIG. 20.
In the curves there appears an exothermic hump directly before, that is still at lower temperature, said slight endothermic valley (FIGS. 1 to 4), which cannot be clearly interpreted, since it may well be just a irregularity in the baseline due to the rather fast heating rate of 10° C. per min and due to its very small size. Its area is only ⅓ of the area of the already slight endothermic valley, making it even less significant.

The DSC of Example 8, 9 and 13 look similar to the DSC of the four Examples 2, 4, 5 and 6. So Examples 2, 4, 5, 6, 8, 9 and 13 do not show at all or at least not clearly a melting of crystallization behavior.

### Discussion of the Curves of the Cooling Cycles:

Croda HP shows in the first cooling cycle a distinct exothermic peak with a delta H of ca. 42 J/g at ca. −35° C.; in the second cooling cycle there a distinct exothermic peak with a delta H of ca. 41 at ca. −35° C. which shows a distinct shoulder at ca. −30° C.; due to its shoulder it has a shape distinctly different from the peak in the first cooling cycle (FIG. 8).
Croda SR shows in the first and second cooling cycle the more or less same distinct exothermic peak with a delta H of ca. 32.4 J/g at ca. −41.5° C. (FIG. 29).

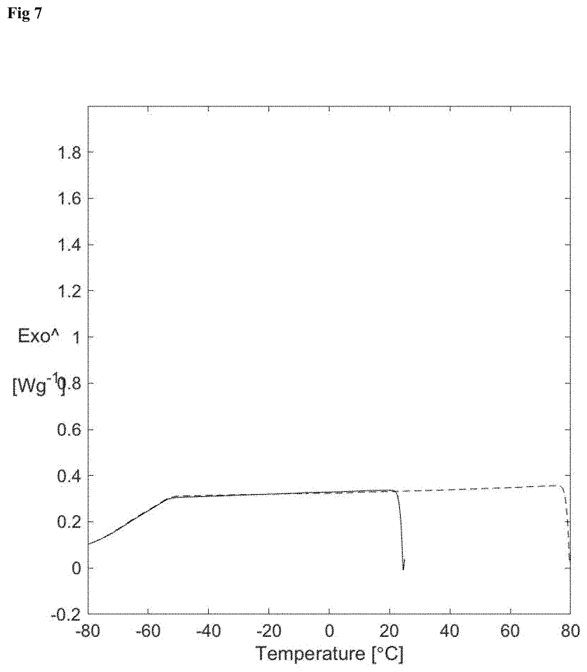

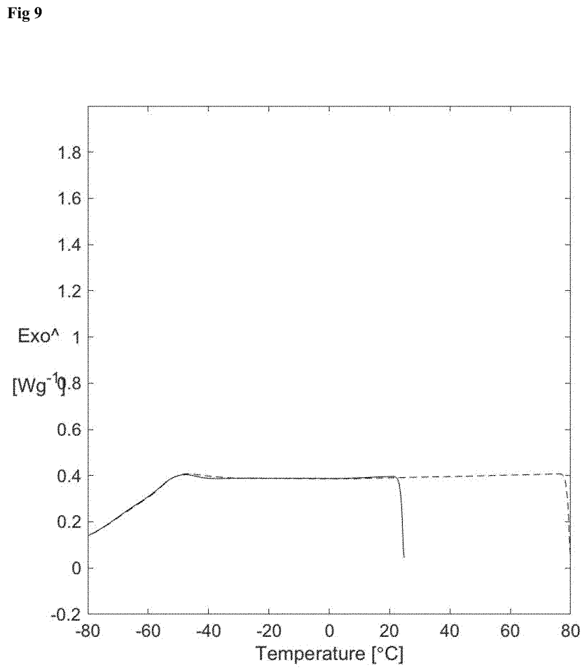

Neither NOF nor Examples 2, 4, 5, 6, 8, 9 and 13 show a peak in any of the two cooling cycles (FIG. 7 (illustrative for the Examples 2, 4, 5, 6, 8, 9 and 13) and FIG. 9).

Results from (C) MALDI and DSC from a Preparative HPLC

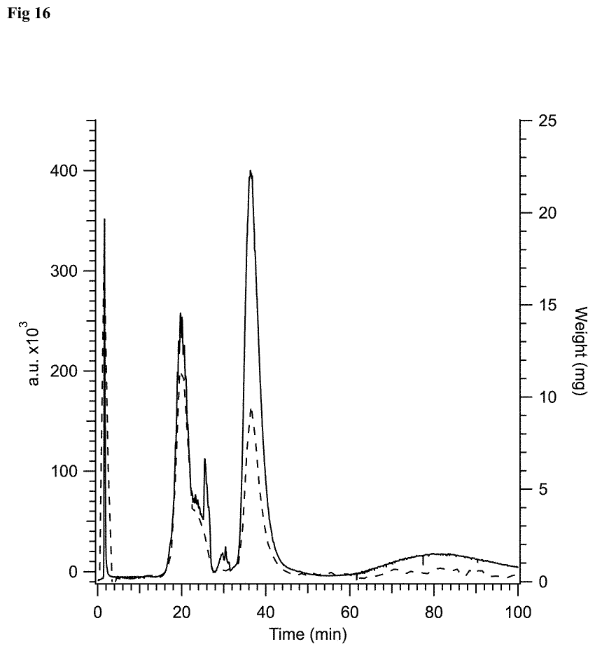

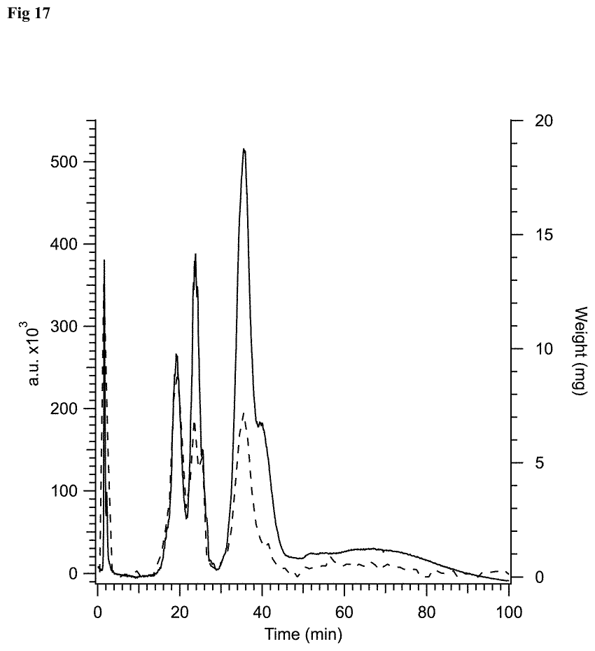

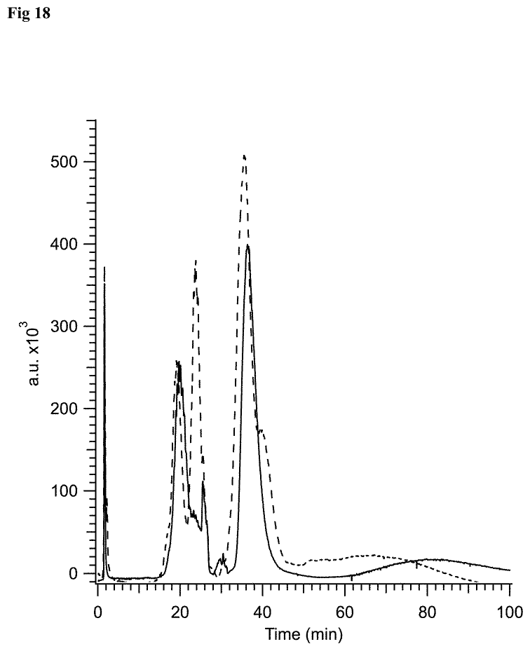

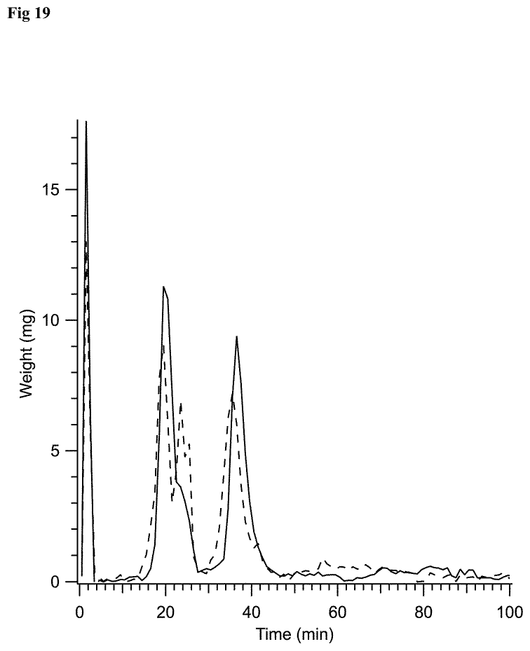

The samples have been tested by MALDI. Example 5 and Croda HP were examined in detail by separation on a preparative HPLC and fractionation into 100 individual fractions, which were consecutively collected between 0 and 100 min, so each fraction was collected for 1 min (10 ml fractions), and that were analyzed by MALDI. The actual weight of all fractions was determined and a weight distribution was created and overlaid with the UV chromatogram:
FIGS. 16 and 17: HPLC chromatogram of preparative HPLC with overlay of UV absorption (solid line) and weight distribution (dashed line), Example 5 and Croda HP respectively
FIGS. 18 and 19: HPLC chromatogram of preparative HPLC, overlay of Example 5 (solid line) and Croda HP (dashed line), UV absorption and weight distribution respectively

From this separation pure fractions of PEO sorbitan mono oleate were tested by DSC: Fractionation of Example 5 yielded pure PEO sorbitan monoester fractions, which also did not show any melting peaks in DSC analysis.

In a MALDI mass spectrum all ethoxylated distributions are separated by 44 Da, which is equal to one EO unit. In order to calculate the average EO content of a mass distribution the mass peak list was exported and fitted to a Gaussian distribution function:

$$f ( x ) = {ae}^{- \frac{{( x - b )}^{2}}{2 {c}^{2}}}$$

Where a is the height of the Gaussian distribution function, b is the position of the Gaussian distribution function center and c can be used as an estimate of the EO spread or dispersity of the Gaussian distribution function around the center mass. The Gaussian distribution function center position thus indicates the mass of the molecule present in the mixture, which gives the highest MALDI peak.

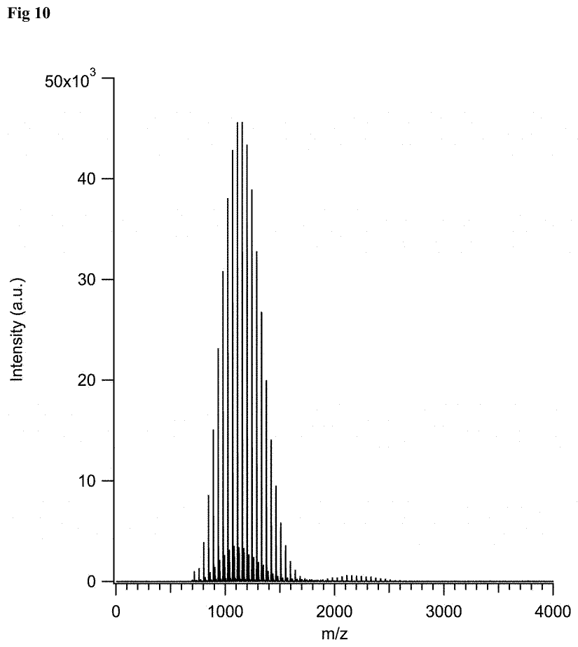

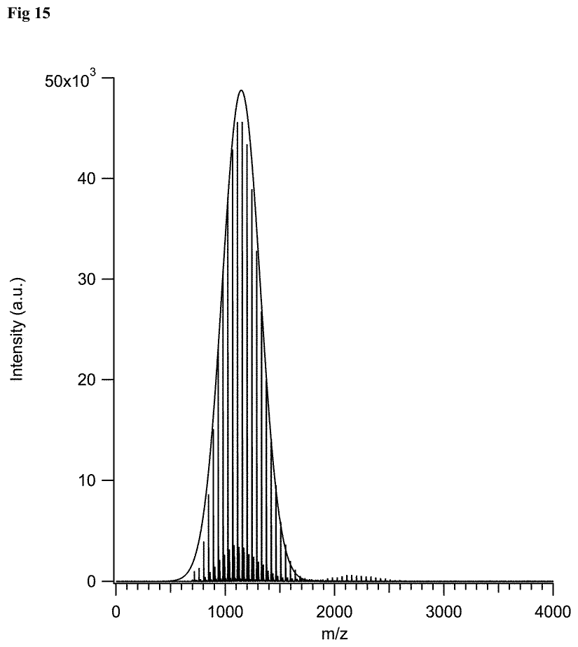

In the case of Example 10, the PEO sorbitan, this value corresponded to 1146 Da. A sodiated PEO sorbitan with 21 EO units has a molecular mass of 1112 Da and a sodiated PEO sorbitan with 22 EO units has a mass of 1156 Da. The average integer EO number for this Gaussian distribution function will thus be estimated to be 22 (FIGS. 10 and 15: Example 10 without and with overlay of the curve of the Gaussian distribution function).

The same methodology can be used for analysis of the pure PEO sorbitan monooleate fractions. Non-fractionated products, though, contain PEO sorbitan mono- di and tri-esters with overlapping distributions due to the fact that one oleate, having 264 Da, is isobaric with six EO units. The mass peak of a sodiated PEO sorbitan monooleate with 20 EO units has 1332 Da and therefore falls on top of a PEO sorbitan diester with 14 EO units and a PEO sorbitan triester with 8 EO units. It is therefore not possible to calculate the average EO content from a MALDI mass spectrum of non-fractionated samples alone, even with the knowledge of the weights of the HPLC fractions. However, with the knowledge gained from fractionated samples, the average EO content of the non-fractionated samples can be estimated.

### Isosorbide Based Species and PEO Esters:

FIG. 18 shows the overlay of Example 5 (solid line) and Croda HP (dashed line) of the UV absorption. The UV absorption shows between ca. 16 and 27 min major signals. In general, the HPLC column in connection with the gradient that was used (from polar to non-polar) separates according to polarity, the higher polar species elute earlier then the less polar species, so the monoester species elute first, then the diester and later on the species with more than two ester residues. Using MALDI based on the preparative HPLC samples, the monoester species were further analyzed for the distribution of their molecular weights. In the same way, the major signals between ca. 30 and 46 min have been identified and assigned to diester species.

In case of the monoester species, which elute between ca. 16 and 27 min:
the major signals of Example 5 have been assigned to PEO sorbitan monoester species with varying number of EO units;
the major signals of Croda HP have been assigned to
   PEO sorbitan monoester species with varying number of EO units, to
   PEO isosorbide monoester species with varying number of EO units, and to
   PEO monoester, that is to polyoxyethylated fatty acid esters, with varying number of EO units.

In case of the diester species, which elute between ca. 30 and 46 min:
the major signals of Example 5 have been assigned to PEO sorbitan diester species with varying number of EO units;
the major signals of Croda HP have been assigned to
   PEO sorbitan diester species with varying number of EO units, and to
   PEO isosorbide diester species with varying number of EO units.
   PEO diester, that is to PEG with fatty acid esters on both sides, with varying number of EO units.

The isosorbide based species and the PEO ester species elute noticeably later than the sorbitan species, and this both in case of the mono- and of the diester species, even though there is an overlap due to the distribution of the molecular weight which is caused by the distribution of the number of EO units.

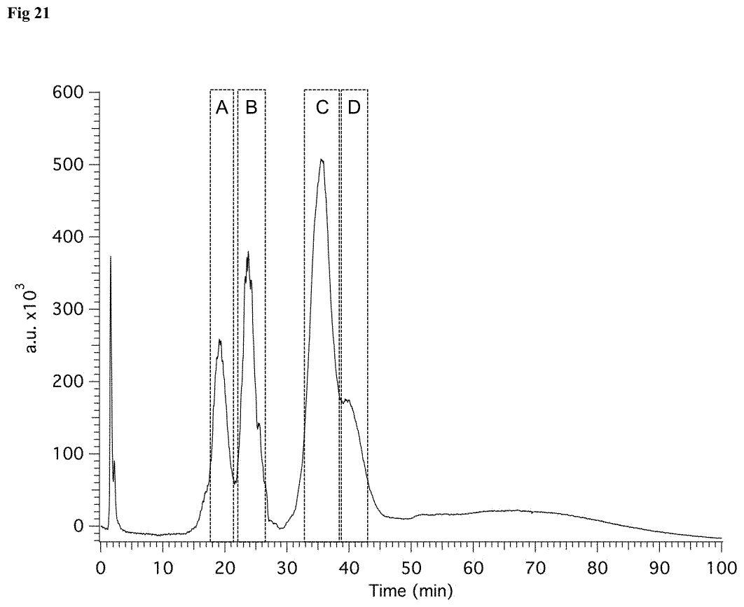

The isosorbide based species and the PEO ester species actually more or less coelute. FIG. 21 illustrates the time ranges where the various species elute in case of Croda HP
A: Peak of PEO sorbitan monoester species
B: Peak of PEO isosorbide monoester and PEO monoester species
C: Peak of PEO sorbitan diester species
D: Peak of PEO isosorbide diester and PEO diester species

Also in case of Example 5 also PEO esters were observed, but only in trace or small amounts in comparison to the major peaks of the PEO sorbitan esters.

In case of Example 10 also PEO isosorbides were observed, but only in trace amounts just above the noise level in comparison to the major peaks of the PEO sorbitan.

Isosorbide species have not been observed in Example 5.

### Estimation of the Average Number of EO Units of the PEO 1,4-Sorbitan Monoester Species in Example 5, NOF, Croda HP and Croda SR:

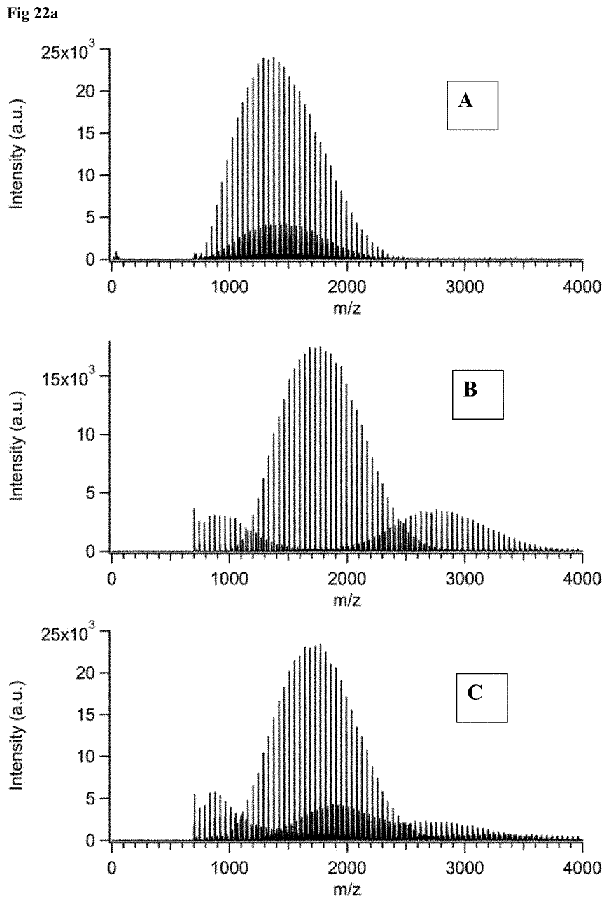

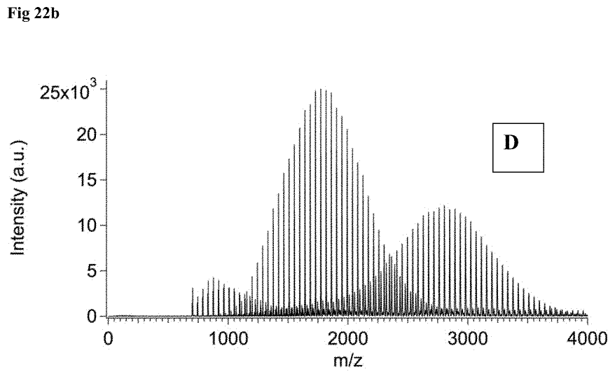

In general any of the ethoxylated species in Example 5 shows lower number of EO units in comparison the respective species in Croda HP and in Croda SR, the difference is always roughly between 5 and 10 EO units. FIG. 22a and FIG. 22b illustrate how this shift of the average number of EO units affects the m/z distribution of the MALDI spectrum:
A: Example 5
B: NOF
C: Croda HP
D: Croda SR

Obviously the MALDI peaks in case of Example 5 have been shifted to lower m/z values compared to NOF, Croda HP and Croda SR.

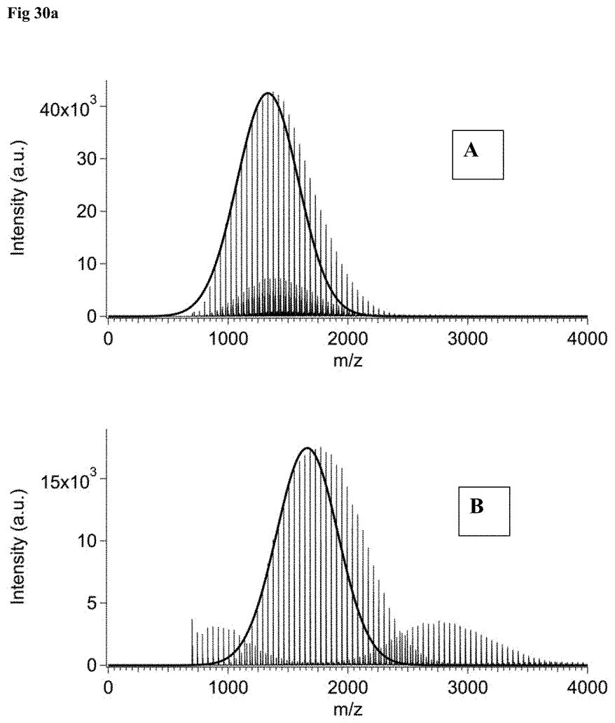

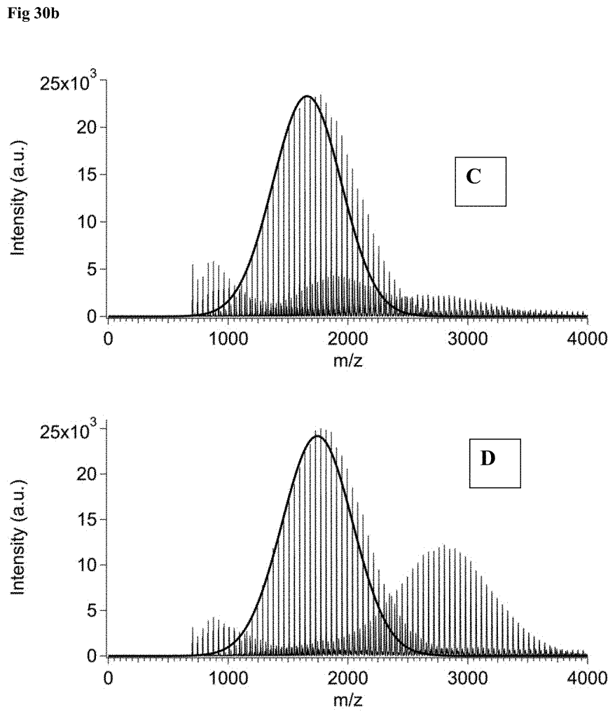

The MALDI mass distribution of pure 1,4-sorbitan monoester fractions fits well to a Gaussian distribution function. In the case of non-fractionated material, that is Example 5, NOF, Croda HP and Croda SR, the main mass distribution contains overlapping mass distributions due to the presence of PEO sorbitan mono- di- and tri-oleate, which are all isobaric molecules. The polyester species are present in a lower amount than the monoesters but will shift the total mass spectrum slightly towards higher masses. A MALDI mass distribution from a non-fractionated sample will thus deviate from a Gaussian distribution function. If, however, a Gaussian distribution function is fitted to the left side of the mass distribution as illustrated in FIG. 30a and FIG. 30b, the center mass peak (b, the position of the Gaussian distribution function center) is a good estimation of the average number of EO units of the 1,4-sorbitan monoester species. This estimation was tested and verified for three samples (Example 5, NOF, Croda HP and Croda SR) of which the two samples Example 5 and Croda HP had been subjected to fractionation and detailed analysis, results are given in Table 3:

TABLE 3

| Sample | b (m/z) | Average EO units |
|---|---|---|
| (A) Example 5 | 1331 | 20 |
| (B) NOF | 1660 | 27 |
| (C) Croda HP | 1659 | 27 |
| (D) Croda SR | 1745 | 29 |

### MALDI of Examples 2, 4, 5, 6, 8, 9, 13 Shows Absence of Isosorbide Species or of Sorbitol Species:

With MALDI no isosorbide species, such as PEO-isosorbide or PEO-isosorbide-fatty acid ester, were detectable in the Examples 2, 4, 5, 6, 8, 9 and 13.
With MALDI no sorbitol species, such as sorbitol ester ethoxylates, were detectable in the Examples 2, 4, 5, 6, 8, 9 and 13.

### MALDI of Example 5, NOF, Croda HP and Croda SR for Analysis of Width of Distribution and of Number of Maxima:

The MALDI of Example 5 shows a distribution of signals with only one maximum, whereas the MALDI of NOF, Croda HP and Crode SR show in the signal distribution in addition to a main maximum two additional maxima; one of the additional maxima has a b value at a lower m/z value relative to the b value of the main maximum, the other additional maximum has a b value at a higher m/z value relative to the b value of the main maximum. Both additional maxima have a lower intensity than the main maximum.

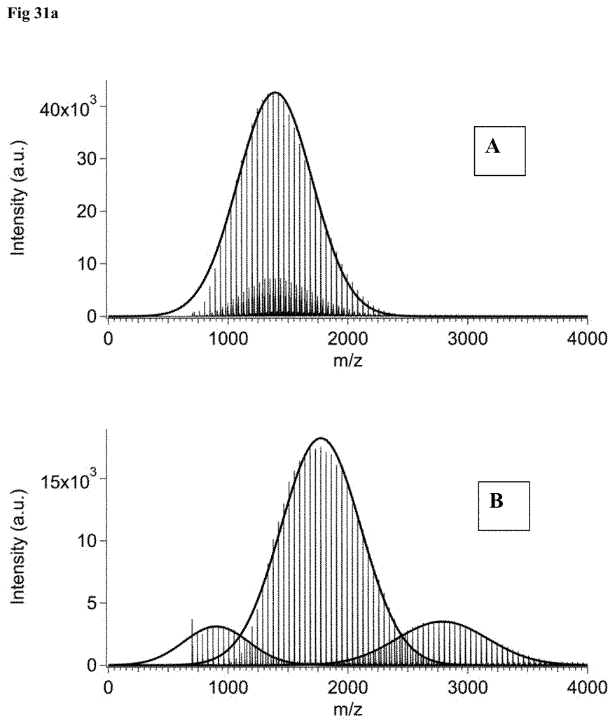

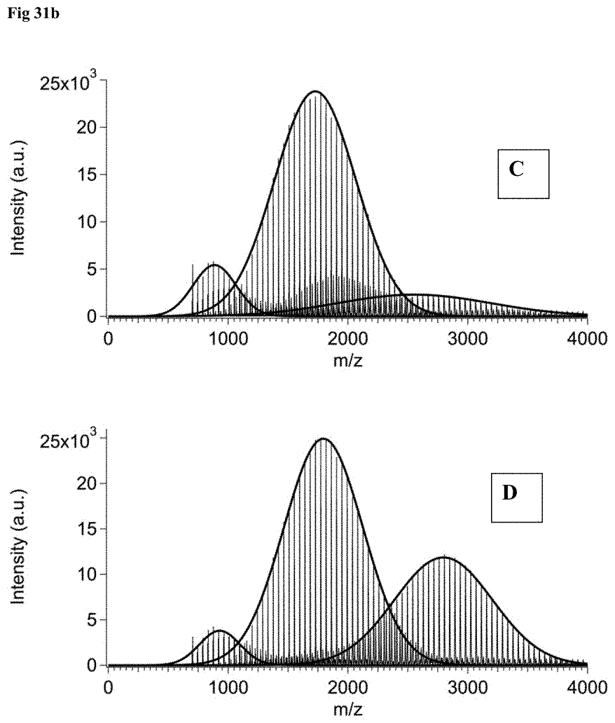

Table 4 shows the b values of the three Gaussian curves fitted to each the respective maximum, as well as the b value of the Gaussian curve fitted to the one maximum in the MALDI spectrum of Example 5. These fitted curves are illustrated in FIG. 31a and FIG. 31b.

TABLE 4

| | b (m/z) | | |
|---|---|---|---|
| | fit of the | fit of the | fit of the |
| Sample | left maximum | main maximum | right maximum |
| (A) Example 5 | — | 1392 | — |
| (B) NOF | 900 | 1774 | 2788 |
| (C) Croda HP | 886 | 1727 | 2553 |
| (D) Croda SR | 930 | 1795 | 2797 |

The MALDI spectrum of Examples 2, 4, 5, 6, 8, 9 and 13 show a signal distribution with only one maximum.

This difference of the products according to instant invention versus the known polysorbates products can also be illustrated when only one Gaussian curve is fitted to all the signals, that is to the whole distribution, in a MALDI spectrum. The c value of the Gaussian distribution function can be used as an estimate of the spread of the m/z values of the signals, that is of the dispersity of the Gaussian distribution function around the center m/z value of the Gaussian distribution function, which is expressed by the b value. Table 5 shows these c values for Example 5, NOF, Croda HP and Croda SR.

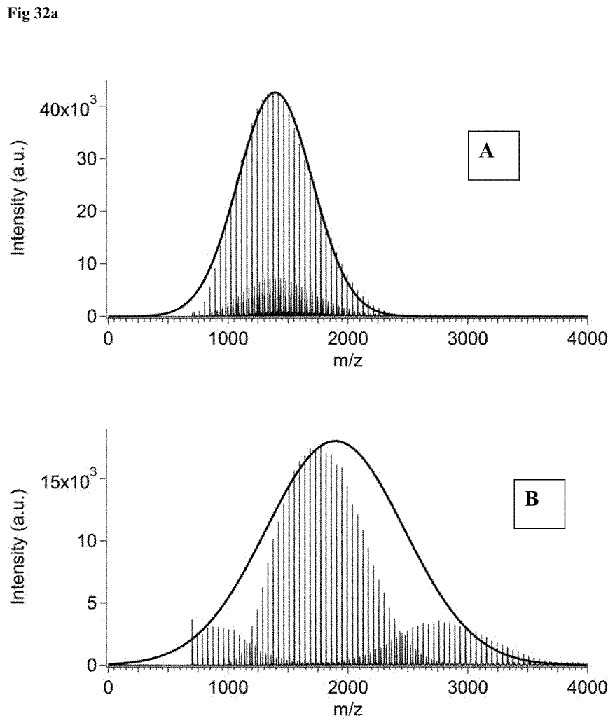

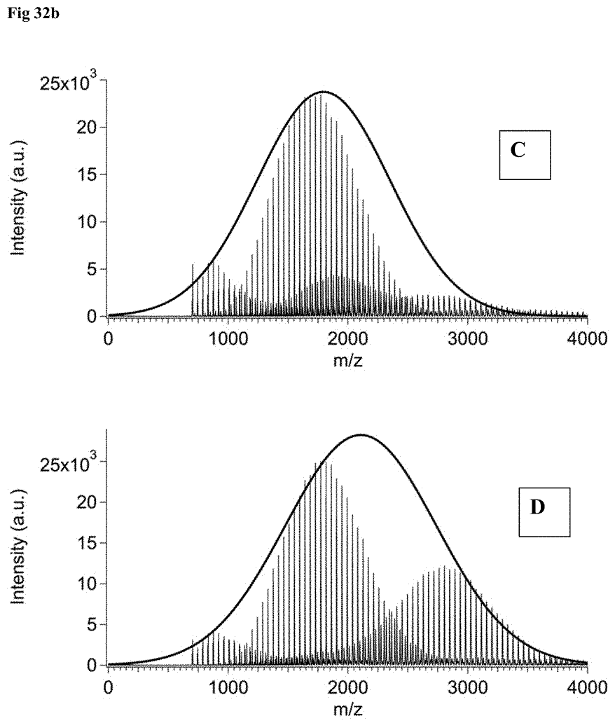

This fit of one Gaussian curve to all the signals in the MALDI spectrum is illustrated in FIG. 32a and FIG. 32b.

TABLE 5

| | c (m/z) |
|---|---|
| | one fit of the |
| Sample | whole distribution |
| (A) Example 5 | 440 |
| (B) NOF | 816 |
| (C) Croda HP | 785 |
| (D) Croda SR | 981 |

### Example 10—PEO Sorbitan from 1,4-Sorbitan Using 20 EO

200 g Naphtha (petroleum), heavy alkylate, CAS 64741-65-7, 100 g (0.61 mol, 1 equiv) 1,4-sorbitan, prepared according to Example 11, and 0.6 g KOH were charged into a 4 L autoclave. The autoclave was rendered inert by evacuating first and then applying afterwards 0.5 bar pressure with N₂, this was done for four times in total.

The mixture was heated to 150° C., 553 g (12.6 mol, 20.7 equiv) ethylene oxide were added in such speed that the temperature did not raise above 160° C. and the pressure did not raise above 3.8 bar; the addition was done in 4 h. Then the mixture was stirred for 2 h at 150° C.

After cooling to 60° C. 2.3 g AcOH were added. Two phases formed, one with solvent, the other with product, and were separated. Residual solvent was removed by steam distillation at a rotary evacuator. 625 g product was obtained.

Yield: 95% based on the assumption that a PEO sorbitan with an average of 20 EO was obtained. This assumption was also applied when this product was used in further reactions. ¹H-NMR and ¹³C-NMR confirmed the structure.

DSC analysis showed no sign of crystallization or melting, neither in both heating cycles nor in both cooling cycles.

### Example 11—1,4-Sorbitan

D-sorbitol (300 g, 1.647 mol, 1 equiv) was charged into a 1.5 L reactor. p-Toluenesulfonic acid monohydrate (2.665 g, 0.014 mol, 0.0085 (0.85%) equiv) was charged, followed by charging of TBAB (9.6 g, 0.03 mol, 0.0182 (1.81%) equiv). Vacuum of reactor 4 to 6 mbar was applied. Then the mixture was heated to 110° C. (the mixture melted at around 90° C.) and stirred at 110° C. for 6 hours. The mixture was cooled to 70 to 75° C. in 30 min. Ethanol (150 mL) was charged. The resulting mixture was stirred at 70 to 75° C. for 2 hours and formed a clear solution. Then the solution was cooled to 20° C. in 3 hours. A yellow suspension was formed. Isopropanol (150 mL) was charged. The mixture was cooled to 0° C. in 1 hour. The mixture was slurry at 0° C. for 4 hours. The mixture was filtered, and the cake was washed with isopropanol (150 mL). The cake was dried at 50° C. for 16 hours under vacuum to provide 142.2 g of product as white solid.

Yield 52.6%

¹H NMR and ¹³C NMR confirmed the structure.

GC area-%:
1,4-Sorbitan 97%
Isosorbide 0.14%
D-Sorbitol 0.12%

Specific Rotation: −22.26°, c=3.1 (water)

### Comparative Example 1

From Nov. 4 to 7, 2018, on the Walter E Washington Convention Center, Washington, D.C., the conference “aaps 2018 PharmSci 360” was held with a Move-In on Friday, Nov. 2, 2018 and Pre-Conference Activities on Saturday, Nov. 3, 2018.

From 9:00 am to 5:00 pm of these Pre-Conference Activities Workshops and Short Courses took place. One of these Workshops took place between 9.45 AM and 10:15 AM with the title: “SC1-Synthesis and Control of Polysobates for Bioüharmaceuticel Applications”, which was held by Sreejit R. Menon, representing the company CRODA, www.crodahealthcare.com, Croda, Inc., Edison, N.J., USA.

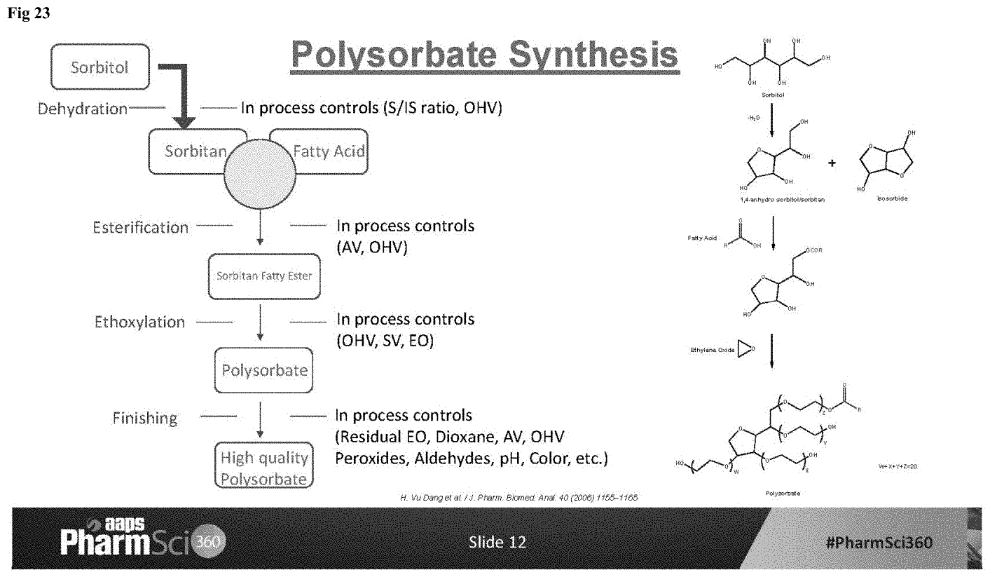

The presentation showed on slide 12 the Polysorbate Synthesis of Croda, see FIG. 23, which uses the sequence:

Sorbitol-(Dehydration)->Sorbitan-(Esterification with Fatty Acid)->Sorbitan Fatty Ester-(Ethoxylation)->Polysorbate-(Finishing)->High quality Polysorbate.

According to this sequence Crode produces two product ranges:
Croda HP, also called Tween 80 HP, the abbreviation “HP” means “high purity”
Croda SR, the abbreviation “SR” means “super refined”, also called “SR PS 80” (meaning super refined polysorbate 80), Super Refined Polysorbate”

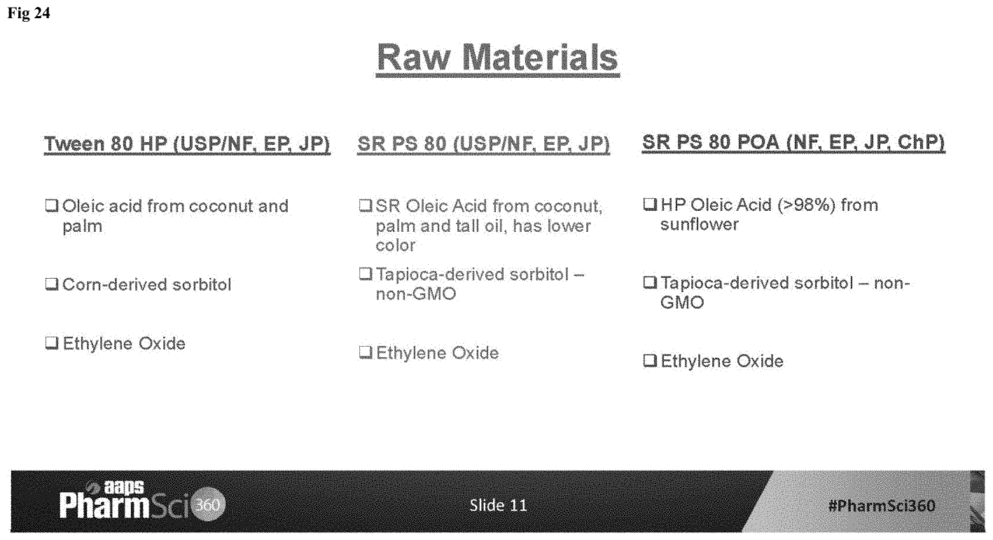

Slide 11, see FIG. 24, lists the Raw Materials for these two product ranges.

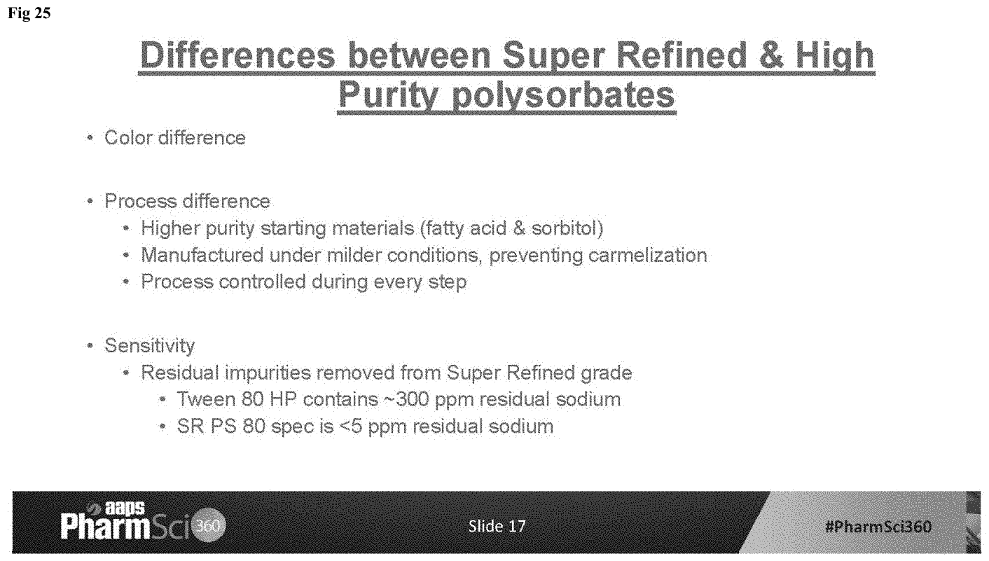

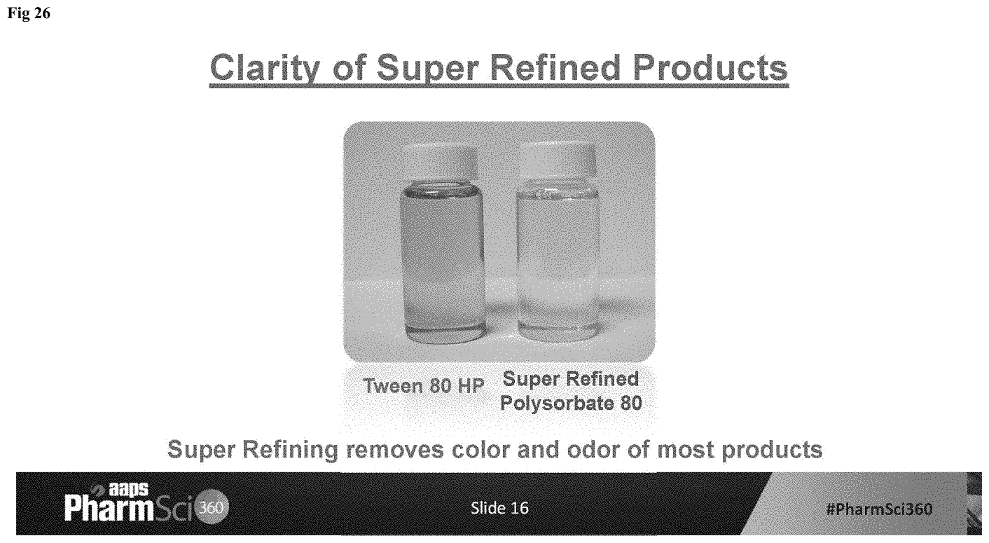

On Slide 17, see FIG. 25, the differences of Croda HP and Croda SR:
1. the process differences for the SR grade versus the HP grade are:
   Higher purity starting materials (fatty acid & sorbitol)
   Manufactured under milder conditions, preventing carmelization
   Process controlled during every step
2. color difference: the HP grade has a yellowish color, whereas the SR grade is almost colorless, this is illustrated on Slide 16, see FIG. 26. The original presentation was not black-white, but colored, but still the gray scale reproduction shows the yellowish color of Croda HP in form of a darker hue compared to the sample of Croda SR.

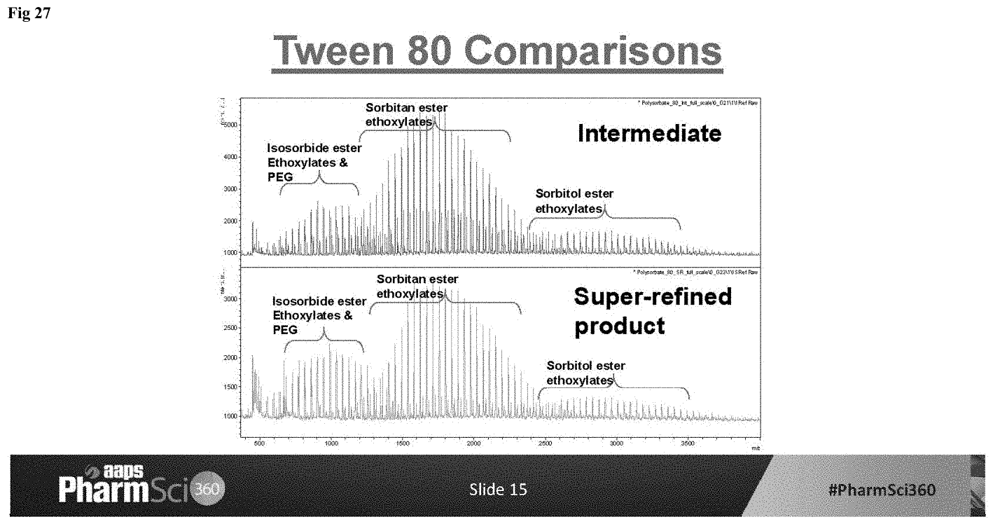

In Slide 15, see FIG. 27, the MALDI spectrum of the SR grade is shown. Three dominant peaks areas are characterized by the chemical species which give rise to these peak areas:
1. Isosorbide ester Ethoxylates & PEG
2. Sorbitan ester ethoxylates
3. Sorbitol ester ethoxylates

Clearly the MALDI spectrum shows even for the SR grade, which is the grade with the highest purity that is currently available on the market not only the one desired peak area of Sorbitan ester ethoxylates, but also significant peak areas caused by the presence of isosorbide and sorbitol derivatives, which are present in the SR grade.

### Example 12—Oleoyl Chloride

A two-neck round bottom flask was charged with oleic acid (469.3 g, 1.64 mol, 1.0 equiv) and the flask was purged with N₂. Dichloromethane (DCM) (1520 mL) was added, a clear, colorless solution formed. Then oxalyl chloride (288 ml, 3.3 mol, 2.0 equiv) was added dropwise at room temperature over 50 min while stirring, then the reaction mixture was stirred at room temperature for 2 h. The DCM and excess oxalyl chloride were removed at the rotary evaporator at ca. 35° C. and ca. 450 to 8 mbar followed by drying under vacuum. The yield of oleoyl chloride was assumed to be 100%.

### Example 13—Polysorbate 80

PEO sorbitan (1001.9 g, 0.96 mol, 1.0 equiv, prepared according to Example 10) were weighed into a 21 reactor and the atmosphere in the flask was exchanged for N₂. Oleoyl chloride (435.5 g, 1.34 mol, 1.4 equiv, prepared according to Example 12) was added at room temperature during ca. 40 min and the reaction mixture was stirred for 1 h at room temperature. Then the reaction mixture was heat up to 60° C. and vacuum was applied under stirring (200 mbar) for 1 day.

The formed HCl could be removed and the pH increased to 5.9. The pH was measured preparing a solution of a sample of the product in water with a content of 5 wt % of the sample.
(H)¹³C NMR method: No isosorbide species, such as PEO-isosorbide or PEO-isosorbide-fatty acid ester, were detectable.
(A) HPLC-ELSD method: No isosorbide species, such as PEO-isosorbide or PEO-isosorbide-fatty acid ester, were detectable.

### Example 14—Quantification of PEO Isosorbide Monooleate

### Preparation of Calibration Material

The prep-HPLC method as described under (C1) Sample Preparation and preparative HPLC (except for the last sentence “The evaporated fractions were then used for DSC analysis.”) was used to separate PEO isosorbide oleate, prepared according to example 15. The material eluted, in time similar to the second peak, the peak B (see FIG. 21 as example) in the separation process of PS80. Three clean fractions were extracted and combined to get a broad PEO distribution and a large amount of material. The material was identified as PEO isosorbide monooleate using MALDI (method as described under (C2) for the HPLC fractions)

PEO isosorbide oleate with an average of 12 EO units, which is needed for standardization purpose, can be synthesized according to known procedures, in this example the PEO isosorbide oleate prepared according to example 15, was used.

### LC-MS(ESI)

The isosorbide calibration material, the PEO isosorbide oleate, prepared according to example 15, was dissolved into three separate solutions: at 0.001 mg/ml, 0.002 mg/ml, 0.006 mg/ml. 10 microliter of each of the three solutions was injected into the LC (Water 2795 Alliance HT, Waters AG, 5405 Baden-Dättwil, Switzerland) and loaded onto a C18 column (Luna C18(2), 3 micrometer, 75×4.6 mm, Phenomenex, 63741 Aschaffenburg, Germany). The analyte species were separated using an can (Acetonitrile): H₂O gradient starting at 45 vol % of ACN and increasing to 100 vol % of ACN in 45 min with a flow rate at 0.8 ml/min and a column temperature of 50° C. The separation continued at 100% ACN until reaching 60 min. The species were detected with a mass spectrometer (Waters Micromass Quattro Micro™) equipped with an electrospray ionization source (ESI). The MassLynx V4.0 software was used for data acquisition. Full scan mass spectra were acquired between m/z 200 and 2000 at a speed of 1 scan per second. The parameters for the MS scans were as follows: a desolvation gas temperature of 300° C., ion source temperature of 100° C., a nitrogen gas flow rate of 500 L/hour, nebulizing (N₂) gas pressure was 6 bar, capillary voltage was 3000 V, and the cone voltage was 30 V.

### Calibration Curve for PEO Isosorbide Monooleate

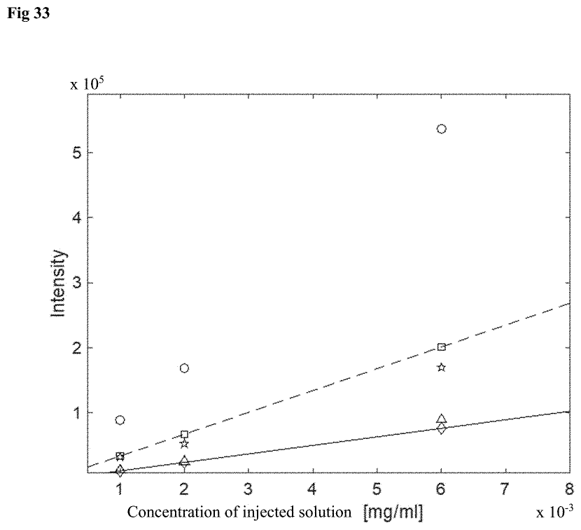

Mass spectra were collected and combined over the peak of interest using the MassLynx V4.0 software. The mass spectra were combined, ranging from the time when PEO isosorbide monooleate species were detected, (elution times between 28 to 34 min depending on sample). Each calibration concentration corresponds to one mass spectrum, used for the calibration curve. Four different distributions were detected in each spectrum, corresponding to four different adducts: Na+, K+, H+ and H₂O. Each adduct distribution displayed a range of peaks, separated by 44 Da, corresponding to one EO unit. The intensity of all peaks of each distribution was added together, given four intensities, one for each adduct (see figure, circle: sum of all adducts, square: H₂O adduct, triangle: H+ adduct, star: Na+ adduct, diamond (visible in the FIG. 33 in the vicinity of the triangles): K+ adduct) and calibration concentration. A calibration curve was calculated (using a standard linear regression) for each adduct, see FIG. 1, over the 0.001 to 0.006 mg/ml range. FIG. 33 shows the curves.

Two calibration curves were used, one for the H₂O adduct (dashed line) and one for the K+ adduct (continuous line), to determine to PEO isosorbide content as these peaks do not overlap with PEO monooleates in the polysorbate samples.

### Determination of Amount of PEO Isosorbide Monooleate in Polysorbate 80 Products

Two polysorbate samples, Croda HP and a polysorbate prepared according to Example 13, were dissolved in H₂O to provide a solution with concentration of 0.05 mg/ml. One combined mass spectrum for each sample was collected, using the same method as for the isosorbide calibration material, the PEO isosorbide oleate, for the peak eluting between 28 to 34 min (sample dependent). The intensities for each adduct distribution was calculated, and the calibration curves were used to calculate the amount of PEO isosorbide monooleate species (in wt % based on the weight of the sample) for each sample. The polysorbate prepared according to Example 17 contained 1 wt % PEO isosorbide monooleate. The Croda HP contained more than 12 wt % PEO isosorbide monooleate, a specific concentration could not be determined as it was outside the scope of the calibration range.

The wt % are based on the weight of the respective polysorbate sample, the Croda HP and the polysorbate prepared according to Example 17.

### Detection Limit:

The saturation of the detector occurs with 10 microliter of a PEO isosorbide oleate solution with a concentration above 0.006 mg/ml, to be more specific, between 0.006 mg/ml and 0.01 mg/ml is injected, this is equal to an amount of between 0.06 microgram and 0.1 microgram of PEO isosorbide oleate. Since 10 microliters of sample solutions of a concentration of 0.05 mg/ml are injected, this injection is equal to an amount of 0.5 microgram of sample material injected. Therefore the detection limit is between 12 wt % and 20 wt %.

### Example 15—PEO Isosorbide Monooleate

Oleic acid (204.1 g) and DCM (660 ml) were mixed, oxalyl chloride (185 g) were added at 20° C. during 40 min, after stirring for 2 h at 20° C. the reaction mixture was concentrated at 33° C. from 450 to 22 mbar, obtained was a yellow, clear liquid (216.6 g).

PEO isosorbide (254.5 g, prepared according to example 16) were weighed into a 21 reactor and the atmosphere in the flask was exchanged for N₂. Oleoyl chloride (160.9 g of the 216.6 g) was added at room temperature during 30 min and the reaction mixture was stirred for 40 min at room temperature. Then the reaction mixture was heat to 60° C. and vacuum was applied under stirring (200 mbar) for 1.5 day.

The formed HCl could be removed and the pH increased to 3.8. The pH was measured preparing a solution of a sample of the product in water with a content of 5 wt % of the sample.

### Example 16—PEO Isosorbide from 1,4-Sorbitan Using 12 EO

200 g Naphtha (petroleum), heavy alkylate, CAS 64741-65-7, 89.1 g (0.61 mol, 1 equiv) isosorbide (Sigma-Aldrich), and 0.6 g KOH were charged into a 4 L autoclave. The autoclave was rendered inert by evacuating first and then applying afterwards 0.5 bar pressure with N₂, this was done for four times in total.

The mixture was heated to 150° C. 333 g (7.6 mol, 12.4 equiv.) ethylene oxide were added in such speed that the temperature did not raise above 160° C. and the pressure did not raise above 3.8 bar; the addition was done in 4 h. Then the mixture was stirred for 2 h at 150° C.

After cooling to 60° C. 1.4 g AcOH were added. Two phases formed, one with solvent, the other with product, and were separated. Residual solvent was removed by steam distillation at a rotary evacuator. ca. 376 g product was obtained.

Yield: 95% based on the assumption that a PEO sorbitan with an average of 120 EO was obtained. This assumption was also applied when this product was used in further reactions.

¹H-NMR and ¹³C-NMR confirmed the structure.

DSC analysis showed no sign of crystallization or melting, neither in both heating cycles nor in both cooling cycles.

### Example 17—Polysorbate 80 with 22 EO

PEO sorbitan (502, 0.44 mol, 1.0 equiv, prepared according to Example 18) were weighed into a 21 reactor and the atmosphere in the flask was exchanged for N₂. Oleoyl chloride (215.8 g, 0.7 mol, 1.5 equiv, prepared according to Example 12) was added at room temperature during ca. 40 min and the reaction mixture was stirred for 1 h at room temperature. Then the reaction mixture was heat up to 60° C. and vacuum was applied under stirring (200 mbar) for 3 days.

The formed HCl could be removed and the pH increased to 6.9. The pH was measured preparing a solution of a sample of the product in water with a content of 5 wt % of the sample.

### Example 18—PEO Sorbitan from 1,4-Sorbitan Using 22 EO

200 g Naphtha (petroleum), heavy alkylate, CAS 64741-65-7, 100 g (0.61 mol, 1 equiv) 1,4-sorbitan, prepared according to Example 11, and 0.6 g KOH were charged into a 4 L autoclave. The autoclave was rendered inert by evacuating first and then applying afterwards 0.5 bar pressure with N₂, this was done for four times in total.

The mixture was heated to 150° C. 612 g (13.92.6 mol, 22.8 equiv) ethylene oxide were added in such speed the temperature did not raise above 160° C. and the pressure did not raise above 3.8 bar; the addition was done in 4 h. Then the mixture was stirred for 2 h at 150° C.

After cooling to 60° C. 2.5 g AcOH were added. Two phases formed, one with solvent, the other with product, and were separated. Residual solvent was removed by steam distillation at a rotary evacuator. 688 g product was obtained.

Yield: 95% based on the assumption that a PEO sorbitan with an average of 22 EO was obtained. This assumption was also applied when this product was used in further reactions.

¹H-NMR and ¹³C-NMR confirmed the structure.

DSC analysis showed no sign of crystallization or melting, neither in both heating cycles nor in both cooling cycles.

1. A method for preparation of polyoxyethylene 1,4-sorbitan fatty acid ester by a reaction REAC-A of polyoxyethylene 1,4-sorbitan with an acid chloride ACIDCHLOR;
ACIDCHLOR is compound of formula (I); 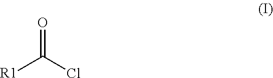
R1 is linear or branched C₁₀₋₂₂ alkyl or linear or branched C₁₀₋₂₂ alkenyl.

2. The method according to claim 1, wherein
R1 is linear C₁₀₋₂₂ alkyl or linear C₁₀₋₂₂ alkenyl, the polyoxyethylene of the polyoxyethylene 1,4-sorbitan, has an average of from 10 to 30 ethylene oxide units, or a combination thereof.

3. (canceled)

4. The method according to claim 1, wherein REAC-A is done at a temperature TEMP-A, no solvent is used for REAC-A, no water is used for REAC-A, no catalyst is used for REAC-A, or a combination thereof, wherein TEMP-A is from 0 to 70° C.

5-7. (canceled)

8. The method according to claim 1, wherein REAC-A is done neat.

9. The method according to claim 1, wherein the polyoxyethylene 1,4-sorbitan is prepared by a reaction REAC-B, wherein 1,4-sorbitan is reacted with ethylene oxide.

10. The method according to claim 9, wherein
the 1,4-sorbitan is prepared by a method SORBID comprising four consecutive steps STEP1, STEP2, STEP3 and STEP4, wherein
in STEP1 D-sorbitol is dehydrated in a dehydration reaction DEHYDREAC in the presence of p-toluenesulfonic acid and tetrabutylammonium bromide, STEP1 provides a mixture MIX1;
in STEP2 ethanol is mixed with MIX1, STEP2 provides a mixture MIX2;
in STEP3 isopropanol is mixed with MIX2, STEP3 provides a mixture MIX3;
in STEP4 1,4-sorbitan is isolated from MIX3.

11. The method according to claim 10, wherein
the p-toluene sulfonic acid is used in form of p-toluenesulfonic acid monohydrate.

12. The method according to claim 10, wherein
no solvent is used for DEHYDREAC, no water is charged for DEHYDREAC, DEHYDREAC is done neat, or a combination thereof.

13. (canceled)

14. (canceled)

15. The method according to claim 10, wherein
STEP2 is done at a temperature TEMP2 of from 60 to 90° C. and/or STEP3 is done at a temperature TEMP3-1 of from 10 to 30° C.

16. (canceled)

17. The method according to claim 10, wherein
after the mixing of isopropanol, STEP3 comprises a cooling COOL3 of MIX3 to a temperature TEMP3-2 of from −5 to 5° C., or
STEP3 comprises stirring STIRR3 of MIX3, STIRR3 is done for a time TIME3-2, TIME3-2 is from 1 to 12 h.

18. (canceled)

19. The method according to claim 17, wherein STIRR3 is done after COOL3.

20. (canceled)

21. The method according to claim 10, wherein
STEP1, STEP2 and STEP3 are done consecutively in one and the same reactor.

22. The method according to claim 9, wherein
the 1,4-sorbitan is prepared by a method SORBIDAQU for preparation of 1,4-sorbitan with three consecutive steps STEP1AQU, STEP2AQU and STEP3AQU, wherein
in STEP1AQU D-sorbitol is dehydrated in a dehydration reaction DEHYDREACAQU in the presence of p-toluenesulfonic acid and tetrabutylammonium bromide, STEP1AQU provides a mixture MIX1AQU;
in STEP2AQU ethanol is mixed with MIX1AQU, STEP2AQU provides a mixture MIX2AQU;
in STEP3AQU isopropanol is mixed with MIX2AQU, STEP3AQU provides a mixture MIX3 AQU;
D-sorbitol is used for STEP1AQU in form of a mixture of D-sorbitol with water.

23. A polyoxyethylene 1,4-sorbitan fatty acid ester obtainable by the method for preparation of polyoxyethylene 1,4-sorbitan fatty acid ester by a reaction REAC-A, with the method and REAC-A as defined in claim 1.

24. A polyoxyethylene 1,4-sorbitan fatty acid ester according to claim 23, wherein
the average number of ethylene oxide (EO) units of the PEO 1,4-sorbitan monoester species in said polyoxyethylene 1,4-sorbitan fatty acid ester is from 19 to 23, or the polyoxyethylene 1,4-sorbitan fatty acid ester contains 10 wt % or less of PEO isosorbide monooleate, the wt % based on the weight of the sample of the polyoxyethylene 1,4-sorbitan fatty acid ester which is analyzed for its content of PEO isosorbide monooleate.

25. A polyoxyethylene 1,4-sorbitan fatty acid ester which does not contain isosorbide species, sorbitol species, or both isosorbide species and sorbitol species.

26. (canceled)

27. A polyoxyethylene 1,4-sorbitan fatty acid ester which shows in a MALDI spectrum a signal distribution with only one maximum, or wherein the MALDI spectrum of said polyoxyethylene 1,4-sorbitan fatty acid ester shows no signals of substances with MW of over 3500 with signal heights of over 5% relative to the maximum of the whole distribution in the MALDI spectrum.

28. (canceled)

29. A polyoxyethylene 1,4-sorbitan fatty acid ester obtained by the method of claim 1 which does show: an endothermic signal in DSC with a maximum of the signal at a temperature of −13° C. or lower or an endothermic signal in DSC with a delta H of not more than 35 J/g.

30. (canceled)

31. A polyoxyethylene 1,4-sorbitan fatty acid ester obtained by the method of claim 1 which does not show: an endothermic signal in DSC with a maximum of the signal at a temperature of above −13° C., an endothermic signal is DSC with a delta H of more than 35 J/g, or an exothermic signal DSC with a maximum of the signal at a temperature of −50° C. or higher.

32-34. (canceled)

35. A method of forming a drug formulation comprising the polyoxyethylene 1,4-sorbitan fatty acid ester according to claim 23, as an excipient in the drug formulations.

36. (canceled)
